(19) United States
(12) Patent Application Publication
(10) Pub. No.: US 2025/0015356 A1
(43) Pub. Date: Jan. 9, 2025

(54) HIGH VOLTAGE LITHIUM BATTERIES COMPRISING A NICKEL-RICH CATHODE AND FLUORINATED ELECTROLYTE

(71) Applicant: SOUTH DAKOTA BOARD OF REGENTS, Pierre, SD (US)

(72) Inventors: Weibing Xing, Rapid City, SD (US); Amir Abdul Razzaq, Rapid City, SD (US); Christopher Poches, Rapid City, SD (US); Regan Ogilvie, Rapid City, SD (US); Haiden Studer, Rapid City, SD (US)

(21) Appl. No.: 18/763,591

(22) Filed: Jul. 3, 2024

Related U.S. Application Data
(60) Provisional application No. 63/511,797, filed on Jul. 3, 2023.

(51) Int. Cl. H01M 10/0569; H01M 4/02; H01M 4/36; H01M 4/38; H01M 4/525; H01M 10/0525; H01M 10/0567; H01M 10/0568; H01M 10/058; H01M 10/42

(52) U.S. Cl. CPC H01M 10/0569; H01M 4/366; H01M 4/382; H01M 4/525; H01M 10/0525; H01M 10/0567; H01M 10/0568; H01M 10/058; H01M 10/4235; H01M 2004/027; H01M 2004/028; H01M 2300/0034; H01M 2300/0037

(57) ABSTRACT

The present disclosure relates to lithium-ion energy storage systems, methods of manufacturing a lithium-ion battery, and lithium-ion batteries having an Ni-rich cathode, an anode, an electrolyte, and a separator. Preferably, the electrolyte is located between the anode and the cathode, and includes a fluorinated solvent, an additive, and a lithium salt.

### CROSS-REFERENCE TO RELATED APPLICATION

This application is related to and claims priority under 35 U.S.C. § 119 to U.S. Provisional Application Ser. No. 63/511,797 filed on Jul. 3, 2023 and entitled “HIGH VOLTAGE LITHIUM BATTERIES COMPRISING A NICKEL-RICH CATHODE AND FLUORINATED ELECTROLYTE”; the entire contents of this patent application are hereby expressly incorporated herein by reference.

### TECHNICAL FIELD

The present disclosure relates generally to lithium-ion batteries, energy storage systems, and related methods of manufacture and use. More particularly, the disclosure relates to lithium-ion batteries comprising a nickel-rich cathode and fluorinated electrolyte.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

The lithium-ion battery technology has become a prominent form of energy storage for a wide range of applications, such as portable electronic devices, electric power tools, electric drive vehicles, unmanned aircraft systems, power grids, etc. According to a United Nations report, the energy demand for lithium-ion batteries has grown from 19 GWh in 2010 to 285 GWh in 2019, which is projected to reach 2,000 GWh in 2030. This global trend of increasing the battery energy storage capacity drives the demand for higher energy density in lithium-ion batteries. However, state-of-the-art lithium-ion batteries are approaching an asymptotic specific energy limit of 250 Wh kg⁻¹ (at the cell level) that cannot adequately meet the increasing energy density demand in current and future applications.

Nickel-rich (Ni-rich) based cathodes (as defined below) possess the promise of providing much higher specific energy (e.g., >400 Wh kg⁻¹). Among Ni-rich cathode materials, low-cost LiNi_{0.8}Co_{0.1}Mn_{0.1}O₂ (NMC811) has a high theoretical specific capacity of >200 mAh/g and, therefore is a promising cathode material to boost lithium-ion batteries' energy densities. Nevertheless, Li/NMC811-based lithium-ion batteries with carbonate solvent-based electrolytes face severe technical challenges, especially when cycled at high upper cut-off voltages, due to electrolyte decomposition, parasitic oxidation reactions at the electrolyte/cathode interface, and irreversible phase changes of the NMC811 cathodes resulting in the dissolution of the transition metals in carbonate electrolytes.

Thus, there is a need in the art for a lithium-ion battery or energy cell with a nickel-rich cathode that has long-term cycle stability (≥1,000 cycles), safety of the battery, and an energy goal exceeding 600 Wh/kg.

While multiple embodiments are disclosed herein, still other embodiments of the present inventions will become apparent to those skilled in the art from the following detailed description, which shows and describes illustrative embodiments of the inventions. Accordingly, the figures and detailed description are to be regarded as illustrative in nature and not restrictive.

### BRIEF SUMMARY

The present invention relates to lithium-ion batteries and methods of making the same. An exemplary embodiment of the present invention can provide a lithium-ion battery, comprising: a cathode having a nickel content of at least 80%; an anode; an electrolyte, located between the anode and the cathode, that includes a fluorinated solvent, an additive, and a lithium salt; and a separator providing a barrier between the anode and the cathode.

In any of the embodiments disclosed herein, the cathode can further comprise active material comprising lithium transition metal oxides, lithium transition metal nitrides, lithium transition metal fluorides, lithium transition metal sulfides, lithium transition metal phosphates, or a mixture thereof.

In any of the embodiments disclosed herein, the cathode can further comprise active material having a redux potential that ranges from about 4.3 volts to about 5 volts.

In any of the embodiments disclosed herein, the cathode can further comprise active material having a redux potential that ranges from about 4.8 volts to about 5 volts.

In any of the embodiments disclosed herein, the cathode can further comprise high redux active material comprising LiNiₓMn_{y}Co₂O₂ (x+y+z=1), LiNi_{1/3}Mn_{1/3}Co_{1/3}O₂ (NMC111), Ni-rich LiNi_{0.8}Mn_{0.1}Co_{0.1}O₂ (NMC811), Ni-rich LiNi_{0.6}Mn_{0.2}Co_{0.2}O₂ (NMC622), Ni-rich LiNi_{0.5}Mn_{0.3}Co_{0.2}O₂ (NMC532), LiMMnO₄ (M=Cr, Co, Fc), LiNi_{0.5}Mn_{1.5}O₄ (LNMO), LiCr_{0.1} Ni_{0.4}Mn_{1.5}O₄, LiM_{0.5}Mn_{1.5}O₄ (M=Cr, Fe, Co, Ni, Cu), LiMg_{0.05}Ni_{0.45}Mn_{1.5}O₄, Li_{1.01}Cu_{0.32}Mn_{1.67}O₄, LiCO_{0.2}Ni_{0.4}Mn_{1.4}O₄, LiNiVO₄, Li_{1.14}Ni_{0.29}Mn_{0.57}O₂, Li₂COPO₄F, LiVPO₄F, LiNiPO₄, LiCoPO₄, LiMn_{0.8}Fe_{0.1}M_{0.1}PO₄ (M=Fe, Co, Ni, Cu), Li-rich layered Li[Li_{1/3}Mn_{2/3}]O₂—LiMO₂ (or Li₂MnO₃—LiMO₂), where M=Ni, Co, Mn, LiNi_{0.8}CO_{0.15}Al_{0.05}O₂ (NCA), LiNi_{1-x-y}CoₓAl_{y}O₂, Li₂FeSiO₄, Li₂CoP₂O₇, Li₂₋ₓCOP₂O₇, and/or a mixture thereof.

In any of the embodiments disclosed herein, the separator can further comprise polymer films, nonwoven fiber, cotton, nylon, polyesters, glass, rubber, asbestos, wood, block polymer derived nanoporous separators, or a combination thereof.

In any of the embodiments disclosed herein, the anode can further comprise anode active material comprising lithium metal, metal predoped with lithium, or metal that is pre-lithiated, or a combination thereof.

In any of the embodiments disclosed herein, the anode can further comprise anode active material comprising carbonaceous materials, lithium titanate spinel Li4Ti5O12, silicon (Si), germanium (Ge), tin (Sn), SiO, SiO2, SnO, SnO2, GeO, GeO2, metal alloy of Si, metal alloy of Ge, metal alloy of Sn, Fe2O3, CoO, Co3O4, TiO2, Cu2O, or MnO, or a combination thereof.

In any of the embodiments disclosed herein, the fluorinated solvent can further comprise fluorinated nitrile, a fluorinated carbonate, a fluorinated borate, a fluorinated ester, a fluorinated ether, a fluorinated sulfone, a fluorinated sulfide, a fluorinated acetal, a fluorinated phosphite, a fluorinated phosphate, or a mixture thereof. In addition, the fluorinated solvent can comprise fluoroethylene carbonate (FEC), methyl trifluoroethyl carbonate, fluoroethyl methyl carbonate, bis(2,2,2-trifluoroethyl) carbonate (FDEC), 3,3,3-trifluoropropylene carbonate (TFPC), 2-trifluoromethyl-3-methoxyperfluoropentane, 1,1,2,2-tetrafluoroethyl 2,2,3,3-tetrafluoropropyl ether, 2-trifluoro-2-fluoro-3-difluoropropoxy-3-difluoro-4-fluoro-5-trifluoropentane (TPTP), 2-trifluoromethyl-3-methoxyperfluoropentane (TMMP), 3,3,3-trifluoropropylene carbonate (TFPC), bis(2,2,2-trifluoroethyl) carbonate (FDEC), 1,1,2,2-tetrafluoroethyl 2,2,3,3-tetrafluoropropyl ether (FEPE), methyl (2,2,2-trifluoroethyl) carbonate or a mixture thereof.

In any of the embodiments disclosed herein, the additive can further comprise passivation film on the lithium metal anode coated in-situ comprising lithium polysulfides (Li₂Sₓ, x=1 to 8), Li nitrate (LiNO₃), Phosphorous pentasulfide (P₂S₅), Cu acetate [Cu(CH₃COO)₂], lanthanum nitrate [La(NO₃)₃], VC: vinylene carbonate, TMSPi: tris(trimethylsilyl) phosphitearious, SN: succinonitrile, LiDFOB, Lithium difluoro (oxalato) borate, lithium polysulfides, or a mixture thereof.

In any of the embodiments disclosed herein, the lithium salt can further comprise lithium hexafluorophosphate, lithium hexafluoroarsenate, lithium perchlorate, lithium tetrafluoroborate, lithium trifluoromethane sulfonate, lithium bis(fluorosulfonyl)imide, lithium bis(trifluoromethanesulfonyl)imide, lithium bis(pentafluoroethylsulfonyl)imide, lithium tris(trifluoromethylsulfonyl)methide, lithium trifluoro tris(pentafluoroethyl)phosphate, lithium bis(oxalato)borate, lithium hexafluoroisopropoxide, lithium malonate borate, lithium difluoro(oxalato) borate, lithium hexafluoroantimonate, LiPF₆, LiBF₄, LiN(CF₃SO₂)₂ and (LiTFSI), or a mixture thereof.

In any of the embodiments disclosed herein, the fluorinated solvent can be combined with an organosilicon-based solvents.

In any of the embodiments disclosed herein, the organosilicon-based solvent can further comprise 2,2-dimethyl-3,6,9-trioxa-2-siladecane, methyl (trimethylsilylmethyl) carbonate, ethyl (trimethylsilylmethyl) carbonate, or a mixture thereof.

An exemplary embodiment of the present invention can provide a lithium-ion energy storage system, comprising: a cathode having a nickel content of at least 80%; an anode; an electrolyte, located between the anode and the cathode, that includes a fluorinated solvent, an additive, and a lithium salt; and a separator providing a barrier between the anode and the cathode.

Another exemplary embodiment of the present disclosure can provide a method for manufacturing a lithium-ion battery, comprising: inserting an electrolyte that includes a fluorinated solvent, an additive, and a lithium salt carrying positively charged ions between a cathode having a nickel content of at least 80% and an anode, within a casing; and inserting a separator between the anode and the cathode to block the flow of electrons inside the lithium-ion battery.

In any of the embodiments disclosed herein, the method can further comprise the step of applying the additive, which is a passivation film, to the anode as a coating in-situ.

In any of the embodiments disclosed herein, the method can further comprise the step of applying radio frequency (RF) sputtering to deposit protective oxide layers on the cathode.

Another exemplary embodiment of the present disclosure can provide a method for improving the capacity and rechargeability of a lithium-ion battery, comprising: replacing a cathode from a lithium-ion battery with a cathode having a nickel content of at least 80% into a lithium-ion battery; and replacing existing electrolyte in the lithium-ion battery with an electrolyte that includes a fluorinated solvent, an additive, and a lithium salt.

These and other aspects of the present invention are described in the Detailed Description of Preferred Embodiments below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE FIGURES

The patent or application file contains at least one drawing executed in color. Copies of this patent or patent application publication with color drawing(s) will be provided by the Office upon request and payment of the necessary fec.

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a pictorial representations of a front view of a physical vapor deposition (PVD) RF sputtering system utilizing an ultrahigh vacuum closed chamber.

FIG. 2 is a pictorial representations of an isolated view of the components of the cathode shown in FIG. 1.

FIG. 3 is a graphical representation of cell voltage (V) versus specific capacity (mAh/g) in Li/NMC811 cells when charged to 4.5V at C/5.

FIG. 4 is a graphical representation of specific capacity (mAh/g) versus cycle number between a baseline electrolyte and a high voltage electrolyte of Li/NMC811 cells subjected to high voltage and high current C rate (1 C charge and 2 C discharge) cycling,

FIG. 5A is a graphical representation of charge/discharge voltage profiles of the coin cells at the first and 470th cycles, respectively. Both the HVE-based and the BE-based Li/NMC811 cells delivered a specific discharge capacity of ˜200 mAh g⁻¹ at the first discharge.

FIG. 5B is a graphical representation of CV profiles of HVE-based cells with oxidation and reduction peaks from 3.6 to 4.2 V assigned to phase transformation in NMC811.

FIG. 5C is a graphical representation of CV profiles of BE-based cells with oxidation and reduction peaks from 3.6 to 4.2 V assigned to phase transformation in NMC811.

FIG. 5D is a graphical representation of rate capability test results for Li/NMC811 cells with HVE and BE electrolytes.

FIG. 5E is a graphical representation of extended cycle life performance (specific capacity vs. cycle number) for Li/NMC811 cells with HVE and BE electrolytes.

FIG. 6A is a graphical representation of Electrochemical Impedance Spectroscopy (EIS) spectra of fresh Li/NMC-811 cells with HVE and BE electrolytes.

FIG. 6B is a graphical representation of EIS spectra of cycled Li/NMC-811 cells with HVE and BE electrolytes.

FIG. 7A is a scanning electron microscopy (SEM) image of NMC811 cathodes: that are pristine.

FIG. 7B is a SEM image of NMC811 cathodes after 200 cycles with BE electrolyte.

FIG. 7C is a SEM image of NMC811 cathodes after 200 cycles with HVE electrolyte.

FIG. 7D is a photograph of a lithium anode disk.

FIG. 7E is a photograph of a lithium anode disk after 200 cycles with BE electrolyte.

FIG. 7F is a photograph of a lithium anode disk after 200 cycles with an HVE electrolyte.

FIG. 8A is a graphical representation of voltage vs. cycle number for Li∥Li symmetric cells with HVE and BE electrolytes at 5 mA cm⁻².

FIG. 8B is a graphical representation of oxidative Linear sweep voltammetry (LSV) scans for different electrolytes, where HVE-LiTFSI and HVE-LiPF₆ represent the type of lithium salt used in the HVE electrolyte components.

FIG. 9 is a pictorial representations of a front view of the reactivity of added molecule (FDEC, FEC, FEMC, DMC, and EC) and NMC811 (001) surface from PBE+u DFT calculations that represents physiosorbed molecule on NMC811 surface with an illustrative FEC molecule and a front representation of reactivity of added molecule (FDEC, FEC, FEMC, DMC, and EC) and NMC811 (001) surface from PBE+u DFT calculations that represents H transferred from the molecule to the NMC811 surface with a small arrow showing the movement of H, and the large arrow showing the configuration after H-transfer.

FIGS. 10A-D are graphical representations of: (A) Charge/discharge voltage profiles of Li/NMC811 cell with FEC-ETMSMC electrolyte; (B) CV of Li/NMC811 cell with FEC-ETMSMC electrolyte; (C) Charge/discharge voltage profiles of Li/NMC811 cell with FEC-1NM2 electrolyte; and (D) CV of Li/NMC811 cell with FEC-1NM2 electrolyte.

FIGS. 11A-B are graphical representations of: (A) Electrochemical cyclic performance of Li/NMC811 cell with single-solvent electrolyte and (B) Oxidative LSV scan with single-solvent electrolyte.

FIGS. 12A-B are graphical representations of Electrochemical performance of Li/NMC811 cells: (A) Cyclic performance with co-solvent electrolyte and (B) Rate test with co-solvent electrolyte.

FIGS. 13A-B are colored graphical representations of Li-ion: (A) Stripping/plating test of Li∥Li symmetric cells and (B) Intercalation/de-intercalation in NMC811∥ NMC811 symmetric cells with co-solvents electrolytes.

FIGS. 14A-B are graphical representations of: (A) Oxidative LSV scans for co-solvent electrolytes and (B) EIS of the co-solvent electrolyte after 200 cycles, where solid lines show raw data and star symbols show filled data.

FIGS. 15A-B are graphical representations of an X-ray photoelectron spectroscopy (XPS) spectra of: (A) Ni 2p3/2, and (B) Li Is for fresh NMC811 cathode and after 200 cycles with FEC-ETMSMC and FEC-1NM2.

FIGS. 16A-B are graphical representations of highest occupied molecular orbitals (HOMO) and lowest unoccupied molecular orbitals (LUMO) levels of the solvents obtained from the DFT calculations. Within FIG. 16A, the solid lines represent HUMO and LUMO for solvents in the presence of FEC (i.e. co-solvents), the dotted lines represent HOMO and LUMO of solvents in the absence of FEC (i.e. single solvents). The horizontal line labeled as vacuum is the vacuum level. The horizontal dashed lines represent the Fermi energy level for Li metal and LiNMC at different Li concentrations. The lowest horizontal dashed line is the Fermi energy level for Li_{1-0.13}NMC. FIG. 16B shows the Fermi level of LiNMC decreases with de-lithiation.

FIG. 17 is a digital photograph of single-solvent electrolytes. Left to right: FEC, ETMSMC, FDEC, MTMSMC, 1NM2, TFPC, and FEMC.

FIG. 18 is a digital photograph of co-solvent electrolytes. Left to right: FEC-ETMSMC, FEC-MTMSMC, FEC-1NM2, FEC-TFPC, FEC-FEMC, and FEC-FDEC.

FIG. 19 is a pictorial representation of an Equivalent circuit, wherein R₀ is bulk resistance, CPE attributes for constant phase element, the symbol ∥ represents parallel circuit, CPE∥R represents interfacial impedance, and W is Warburg (mass transfer) impedance at low frequencies.

FIG. 20 is a pictorial representation of the chemical structure of organic solvents: FEC, FDEC, TFPC, FEMC, MTMSMC, 1NM2, and ETMSMC.

The figures described herein form part of the specification and are included to further demonstrate certain preferred embodiments of the inventions. In some instances, embodiments of the inventions can be best understood by referring to the accompanying figures in combination with the detailed description presented herein. The description and accompanying figures may highlight a certain specific example, or a certain aspect of the inventions. However, one skilled in the art will understand that portions of the example or aspect may be used in combination with other embodiments of the inventions.

An artisan of ordinary skill in the art need not view, within isolated figure(s), the near infinite distinct combinations of features described in the following detailed description to facilitate an understanding of the present disclosure.

### DETAILED DESCRIPTION OF PREFERRED EMBODIMENTS

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

This disclosure relates to lithium-ion batteries and energy storage systems comprising a nickel-rich cathode and a fluorinated electrolyte. The disclosure also describes methods of preparing the batteries and energy storage systems as well as methods of their use.

Beneficially, the batteries and energy storage systems described herein are high voltage and can be used at voltages of about 4.1 or higher, 4.2 or higher, 4.3 or higher, 4.4 or higher, or 4.5 or higher. In addition, the lithium-ion batteries and energy storage systems disclosed herein provide improved capacity over multiple cycles and reduced capacity fade over multiple cycles, despite use at high voltage. Other advantages and benefits are further described herein.

### Definitions

So that this disclosure may be more readily understood, certain terms are first defined. Unless defined otherwise, all technical and scientific terms used herein have the same meaning as commonly understood by one of ordinary skill in the art to which embodiments of this disclosure pertain. While many methods and materials similar, modified, or equivalent to those described herein can be used in the practice of the embodiments of this disclosure without undue experimentation, the preferred materials and methods are described herein. In describing and claiming the embodiments of this disclosure, the following terminology will be used in accordance with the definitions set out below. Terms characterizing sequential order, a position, and/or an orientation are not limiting and are only referenced according to the views presented.

It is to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. The term “or” is synonymous with “and/or” and means any one member or combination of members of a particular list. Furthermore, all units, prefixes, and symbols may be denoted in its SI accepted form.

Numeric ranges recited within the specification are inclusive of the numbers defining the range and include each integer within the defined range. Throughout this disclosure, various aspects of the disclosure are presented in a range format. It should be understood that the description in range format is merely for convenience and brevity and should not be construed as an inflexible limitation on the scope of the inventions. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6, and decimals and fractions, for example, 1.2, 3.8, 1½, and 4¾. This applies regardless of the breadth of the range.

References to elements herein are intended to encompass any or all of their oxidative states and isotopes. For example, discussion of silicon can include Si⁻⁴, Si⁻³, Si⁻², Si⁻¹, Si¹, Si², Si³, or Si⁴ and any of its isotopes, e.g., ²⁸Si, ²⁹Si, and ³⁰Si. A discussion of nickel can include Ni⁻¹, Ni⁰, Ni², Ni³, and Nit and any of its isotopes ⁵⁸Ni, ⁶⁰Ni, ⁶¹Ni, ⁶²Ni and ⁶⁴Ni. A discussion of fluoride can include Fl⁻¹ and any of its isotopes ¹³F, ¹⁴F, ¹⁵F, ¹⁶F, ¹⁷F, ¹⁸F, ¹⁹F, ²⁰F, ²¹F, ²²F, ²⁴F, ²⁵F, ^{26m}F, ²⁷F, ²⁸F, ²⁹F, ³⁰F, and ³¹F.

The term “about,” as used herein, refers to variation in the numerical quantity that can occur, for example, through typical measuring techniques and equipment, with respect to any quantifiable variable, including, but not limited to, mass, power, volume, time, distance, voltage, current, specific discharge capacity, energy density, flow, cycle number, specific energy, bulk resistance, charge transfer resistance, interfacial impedance, mass transfer impedance, and electron volts.

Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur, or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Nanotubes are cylindrical structures formed by nanoparticles such as carbon-based nanoparticles. Nanotubes can be single-walled nanotubes (“SWNT”), multi-walled nanotubes (“MWNT”) which includes double-walled nanotubes (“DWNT”), or a combination of the same. When the nanotube is carbon-based, the abbreviation can be modified by a “C-,” for example, C-SWNT and C-MWNT.

As used herein, the term “energy density” refers to the volumetric (often expressed in Wh/L) or gravimetric (often expressed in Wh/kg) energy (Wh or mWh) delivered during charge/discharge of each cycle can be read from a battery tester. Preferably, the energy density is measured after a standard forming cycle protocol for a full-cell battery. The gravimetric energy density or volumetric energy density can be calculated by dividing the energy by the corresponding mass or volume. Sometimes, only the mass or volume of electrode material is considered in the energy density calculation, which more directly measures the material-dependent characteristics of the energy density. Sometimes, the mass or volume of other components in a full-cell battery are also included in the energy density calculation. In a full-cell battery, the other components can include a current collector (copper foil for an anode, aluminum foil for a cathode), a separator, an electrolyte, electrode leads (often nickel for an anode and aluminum for a cathode), isolating tape, and an aluminum-laminated case or a coin cell case. While these other components are useful to make the cell work, they are not contributing to the energy storage, which means they are considered inactive cell components. The energy density obtained if considering all the components in the cell is more near the true performance of the cell in the end application. Minimizing the mass or volume contribution of these components in the cell will enhance the final cell energy density. Thus, throughout this application, recitation of the volumetric and/or gravimetric energy density will refer to a battery (which would include the inactive cell components).

As used herein, the term “gravimetric specific capacity” refers to the specific capacity of a material based on its mass. The gravimetric specific capacity is often expressed in mAh/g or Ah/g. During cycling with a battery galvanometric tester under designed test protocols, the total charge stored/released during charging/discharging can be read from the tester in the unit of mAh. The gravimetric specific capacity can be calculated by dividing the total charge of discharge capacity during each cycle by the mass loading of electrode materials. For example, if a cell is loaded with 1 mg of anode material and shows a capacity of 1 mAh, the specific capacity of this electrode material will be 1 mAh/1 mg=1000 mAh/g. In the full-cell test, the gravimetric specific capacity can be calculated based on loading the anode, cathode, or total.

As used herein, the term “polymer” refers to a molecular complex comprised of more than ten monomeric units and generally includes, but is not limited to, homopolymers, copolymers, such as for example, block, graft, random and alternating copolymers, terpolymers, and higher “x” mers, further including their analogs, derivatives, combinations, and blends thereof. Furthermore, unless otherwise specifically limited, the term “polymer” shall include all possible isomeric configurations of the molecule, including, but are not limited to isotactic, syndiotactic, and random symmetries, and combinations thereof. Furthermore, unless otherwise specifically limited, the term “polymer” shall include all possible geometrical configurations of the molecule.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

The term “nickel rich” or “high nickel content” is for the purpose of this application defined as being a percentage of nickel equal to or greater than eighty percent (80%) as defined in Guihong Mao, Fangming Xiao, Liming Zeng, Renheng Tang, Jian Li, Qing Zhou, Ying Wang, Improvement of cycle performance of the high nickel cathode material LiNi0.88Co0.07Al0.05O2 for lithium-ion batteries by the spray drying of V2O5, Journal of Alloys and Compounds, Volume 892, 2022, 162161, ISSN 0925-8388.

The main components of a lithium-ion battery or lithium-ion energy storage system include a cathode, an anode, an electrolyte, and a separator.

The term “lithium-ion battery” or “lithium energy storage system”, as used herein, is an advanced battery technology that uses lithium ions as a key component of its electrochemistry. Lithium atoms in the anode are ionized and separated from their electrons during a discharge cycle. The lithium ions move from the anode and pass through the electrolyte until they reach the cathode, where they recombine with their electrons and electrically neutralize. The lithium ions are small enough to be able to move through a micro-permeable separator between the anode and cathode. In part, because of lithium's small size (with only hydrogen and helium being smaller), lithium-ion batteries are capable of having a very high voltage and charge storage per unit mass and unit volume.

The term “cathode,” as used herein, is a positive electrode, and an “anode”, as used herein, is a negative electrode. “Electrolyte”, as used herein, is a conductor of ions from the anode to the cathode where a charge reverses the direction of the ions to flow from the cathode to the electrode. The electrolyte is a chemical that allows an electrical charge to pass between the two terminals. The electrolyte puts the chemicals required for the reaction in contact with the anode and cathode, thereby converting stored energy into usable electrical energy. The term “separator”, as used herein, is a barrier that physically separates the anode and cathode. The primary function of the separator is to prevent physical contact between the anode and cathode, while facilitating ion transport in the lithium-ion battery cell.

The cathode is instrumental with regard to the characteristics of the battery or energy storage system, which includes the battery's capacity and voltage. The active material of the anode performs the role of enabling electric current to flow through the external circuit. When the battery is being charged, lithium ions are stored in the anode. At this point, when the conducting wire connects the cathode to the anode (discharge state), lithium ions naturally flow back to the cathode through the electrolyte, and the electrons separated from lithium ions move along the wire generating electricity. The electrolyte serves as the medium that enables the movement of only lithium ions between the cathode and anode. The separator functions as a physical barrier keeping the cathode and anode apart and prevents the direct flow of electrons while carefully letting only the ions pass through an internal microscopic hole.

### Cathode

The cathode in this disclosure is both high voltage, has a high energy density, and has high nickel or nickel-rich content (defined as equal to or greater than 80%). The operating voltage is high from at least 4.3 to 5 volts versus Li/Li+ as an electrode reference with high specific capacity and high specific energy.

When a Ni-rich cathode is charged to the upper cutoff voltage limit, the electron energy levels of the highest occupied molecular orbitals (HOMOs) of the carbonate-solvent based electrolytes have a higher chemical potential μ_{c} than Ni-rich cathodes which leads to an oxidation reaction of the carbonated-solvent-based electrolytes when used in the Ni-rich cathode based Lithium-ion batteries (LIBs). Thus, in one aspect, for optimal performance of a Ni-rich cathode, an ideal electrolyte should have HOMOs lower than μc of the cathodes and LUMOs (the lowest unoccupied molecular orbitals) higher than the μa of the anodes.

One illustrative, but nonlimiting, specific nickel-rich cathode in this area is a layer structured LiNi_{0.8}Mn_{0.1}Co_{0.102} (NMC811) that has a practical high specific capacity ˜200 mAh/g, a high average discharge voltage ˜4V and a relatively low cost due to its low cobalt content.

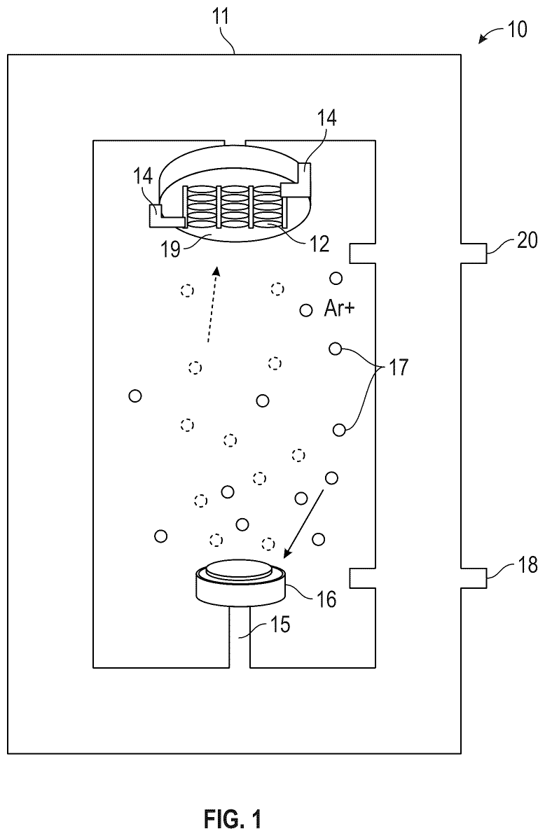

A wide variety of techniques can accomplish the layering process of a nickel-rich cathode. For example, protective oxide layers, e.g., Al2O3, TiO2, SiO2, can be coated on Ni-rich LiNi_{0.8}Mn_{0.1}Co_{0.102} (NMC811) cathodes, including atomic layer deposition (ALD) method, atmospheric-plasma chemical vapor deposition (“CVD”) or physical vapor deposition (“PVD”). Specifically, for a physical vapor deposition process, radio frequencies (RF) sputtering to deposit oxide layers in a Torr combination system is preferred and generally indicated by numeral 10 in FIG. 1. This includes an ultrahigh-vacuum closed chamber 11. The nickel-rich cathode is generally indicated by the numeral 12 and functions as a substrate and is kept at a distance from 5 to 20 centimeters, and preferably from 10 to 15 centimeters from an oxide target 16. These coating processes can be applied to a nickel-rich cathode 12 for protection and are low-cost and, therefore, more competitive for scaling up than the atomic layer deposition (ALD) method.

Argon is injected into the ultrahigh vacuum closed chamber 11 through inlet 20 with an ultrahigh vacuum pump attached to outlet 18. Sputter deposition utilizes an electrically excited argon gas plasma in an ultrahigh vacuum system. The argon ions 17 in the plasma are accelerated toward the nickel-rich cathode 12, which upon bombardment, eject neutral atoms from the surface of the nickel-rich cathode 12. Atoms are ejected from the oxide target 16 by momentum transfer. Radiofrequency (RF) sputtering runs an energetic wave through inert gas, e.g., argon, in a vacuum chamber which becomes ionized. The oxide target 16, which is to become the thin film coating, is bombarded by these high energy ions sputtering off atoms as a fine spray covering the nickel-rich cathode 12 as a substrate to be coated. The oxide target 16 has a support mount 15 that is attached to the bottom of the ultrahigh vacuum chamber 11. The nickel-rich cathode 12 is held in a support member 19 attached to the top of the ultrahigh vacuum chamber 11. The cathode may be mounted to the support member 19 through clips 14. Preferably, radio frequency (RF) sputtering can be conducted at a deposition rate of 0.1 Å s⁻¹ and injecting argon gas with a constant flow of twenty standard cubic centimeters per minute (SCCM).

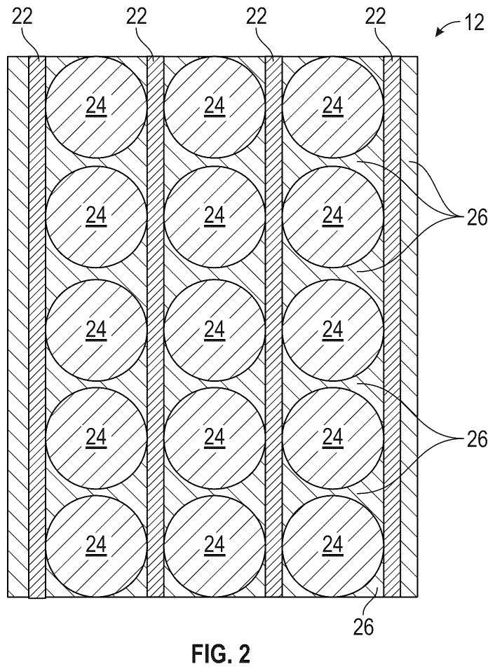

Referring now to FIG. 2, the nickel-rich cathode 12 is broken down into nickel-rich cathode material 24 on aluminum foil or ceramic plate 26 secured by with high temperature resistant adhesive polyimide tape 22. Aluminum foil 26 has been the most widely used cathode current collector for positive electrode materials due to its high conductivity, electrochemical and chemical stability, and low cost., An illustrative, but nonlimiting, example of this type of high temperature resistant adhesive polyimide tape 22 is KAPTON® tape. KAPTON® is a federally registered trademark of DuPont Electronics, Inc, which is a Delaware corporation, having a place of business at 974 Centre Road, Wilmington, Delaware 19805.

These conformal and uniform coatings, targeted to be on the order of one hundred nanometers in thickness, are electrochemically and chemically stable, serving as artificial solid-electrolyte interface (SEI) films. These thin film coatings will provide several performance benefits that include: minimizing parasitic reactions from interactions between the electrolyte and highly reactive, delithiated nickel-rich cathode 12 at high potential voltages; suppress structural changes of the nickel-rich cathode 12 material; and mitigating degradation at elevated temperatures. As a result, protective coatings significantly improve the long-term cycle life stability of the resultant Li/Ni-rich batteries.

Protected nickel-rich powders can be mixed with graphene additives to formulate a nickel-rich cathode to help deliver high specific energy at 0.5 C and up to 3 C under continuous discharge.

The active cathode materials can include lithium transition metal oxides, lithium transition metal nitrides, lithium transition metal fluorides, lithium transition metal sulfides, lithium transition metal phosphates, and/or a mixture thereof. The cathode active material is preferably of a high major redox potential vs. Li/Li+ (i.e., about 5V high voltage cathode). but can include a high major redox potential from about 4.3V to about 5V vs. Li/Li+.

High redox potential cathode active material can include LiNiₓMn_{y}Co₂O₂ (x+y+z=1), LiNi_{1/3}Mn_{1/3}Co_{1/3}O₂ (NMC111), Ni-rich LiNi_{0.8}Mn_{0.1}Co_{0.102} (NMC811), Ni-rich LiNi_{0.6}Mn_{0.2}Co_{0.2}O₂ (NMC622), Ni-rich LiNi_{0.5}Mn_{0.3}Co_{0.2}O₂ (NMC532), LiMMnO₄ (M=Cr, Co, Fc), LiNi_{0.5}Mn_{1.5}O₄ (LNMO), LiCr_{0.1}Ni_{0.4}Mn_{1.5}O₄, LiM_{0.5}Mn_{1.5}O₄ (M=Cr, Fe, Co, Ni, Cu), LiMg_{0.05}Ni_{0.45}Mn_{1.5}O₄, Li1.0∥Cu_{0.32}Mn_{1.67}O₄, LiCo_{0.2}Ni_{0.4}Mn_{1.4}O₄, LiNiVO₄, Li_{1.14}Ni_{0.29}Mn_{0.57}O₂, Li₂CoPO₄F, LiVPO₄F, LiNiPO₄, LiCOPO₄, LiMn_{0.8}Fe_{0.1}M_{0.1}PO₄ (M=Fe, Co, Ni, Cu), Li-rich layered Li [Li_{1/3}Mn_{2/3}]O₂—LiMO₂ (or Li₂MnO₃—LiMO₂), where M=Ni, Co, Mn, LiNi_{0.8}Co_{0.15}Al_{0.05}O₂ (NCA), LiNi_{1-x-y}CoₓAl_{y}O₂, Li₂FeSiO₄, Li₂CoP₂O₇, Li₂₋ₓCoP₂O₇, and/or a mixture thereof.

### Anode

The anode can take a number of forms. The anode active material can be lithium metal or ionically pre-doped with lithium material or pre-lithiated material. Pre-lithiated material can be accomplished chemically or electrochemically via in-situ or ex-situ methods that may potentially use lithium metal or stabilized lithium metal powder.

The anode active materials can be selected from a group consisting of carbonaceous materials, lithium titanate spinel Li₄Ti₅O₁₂, silicon (Si), germanium (Ge), tin (Sn), metal oxides, or a mixture thereof.

The carbonaceous material can include graphite, soft carbon, hard carbon, graphene, graphene oxide, and carbon nanotube. The graphite material can include natural graphite, crystalline flack graphite, amorphous graphite, pyrolytic graphite, graphene, lump graphite, and graphite fiber, mesocarbon microbeads. The soft carbon material can include organic precursors that melt before they pyrolyze (graphitizable), neatly stacked graphene layers under less long-range order as well as petroleum coke. The hard carbon material can include organic precursors that char as they pyrolyze (non-graphitizable), graphene layers that are not neatly stacked, and non-crystalline and macroscopically isotropic. The silicon material can include SiO, SiO₂, SnO, SnO₂, GeO, GeO₂, and metal alloys of Si, Ge, and Sn. The metal oxides can include Fe₂O₃, CoO, Co₃O₄, TiO₂, Cu₂O, MnO. This is in addition to all mixtures and combinations thereof.

### Separator

Separators in lithium-ion (Li-ion) batteries literally separate the anode and cathode to prevent a short circuit. In addition, the separator also provides a battery's or energy cell's thermal stability and safety. A separator affects not only battery performance parameters, including cycle life, energy and power density, and safety.

There are a wide variety of materials that can be used for a separator. This includes, but is not limited to, polymer films including polyolefin such as polyethylene, polypropylene, poly(tetrafluoroethylene), polyvinyl chloride, nonwoven fibers including cotton, nylon, polyesters, glass, and naturally occurring substances including rubber, asbestos, wood, block polymer derived nanoporous separators, or mixtures and/or combinations thereof.

### Electrolytes

Liquid electrolytes for LIBs are generally composed of salt, additives, and solvents. The most commonly used salt in electrolytes is believed to be LiPF₆. However, hydrofluoric acid (HF) formation is a common problem with LiPF₆ salt, which can dissolve transition metals in NMC cathodes. Therefore, alternative salts for lithium-ion batteries have been investigated; for example, LiTFSI and LiFSI have been considered a promising candidate because of their ability to protect the anode through the formation of solid electrolyte interphase (SEI) due to these salts having a strong electron withdrawing group (—CF3 or —F) which, without being limited to theory, is believed to be beneficial for the formation of SEI layer when contacted with a Lithium metal anode. The combination of LiTFSI and LiDFOB helps attain stable cyclic performance with high-voltage Ni-rich cathodes which is achieved by protecting both the anode and cathode through the formation of a stable interfacial layer.

The use of voltage stable electrolytes, working in concert with surface nano-coated high nickel cathodes, will render synergistic performance benefits to the resultant lithium cells, which are stable formulate novel, multifunctional electrolytes that are stable at high charge voltages that are up to five volts and able to form SEI films on lithium anode in-situ. As shown in Table 1 below, the preferred combination is a fluorinated solvent, additives such as SEI film formation on a lithium anode, and lithium salts.

However, potentially, the electrolyte can be selected from a group consisting of a non-aqueous electrolyte, an aprotic liquid electrolyte, a room temperature ionic liquid electrolyte, a polymeric electrolyte, a polymeric gel electrolyte, a solid-state electrolyte, or a mixture thereof. In general terms, the non-aqueous electrolyte can comprise an electrolyte salt dissolved in an organic solvent or a mixture of organic solvents.

TABLE 1
Electrolyte Functionality and Preferred Components

| | Electrolyte Component |
|---|---|
| Fluorinated solvents: high | TFPC: 3,3,3-trifluoropropylene carbonate; |
| voltage, nonflammable | FDEC: bis(2,2,2-trifluoroethyl) carbonate; |
| | FEPE: 1,1,2,2-tetrafluoroethyl 2,2,3,3- |
| | tetrafluoropropyl ether; FEC: fluoroethylene |
| | carbonate |
| Additives: SEI | VC: vinylene carbonate; TMSPi: |
| film formation | tris(trimethylsilyl) phosphitearious; SN: |
| on lithium anode | succinonitrile; LiDFOB: Lithium |
| | difluoro(oxalato)borate; lithium |
| | polysulfides. |
| Li salts: conductive, high | LiPF₆, LiBF₄, LiN(CF₃SO₂)₂ (LiTFSI) |
| voltage, wide temperature | |

The novel fluorinated solvents will provide high voltage stability and nonflammability to the electrolyte due to, respectively, strong electron-withdrawing from fluorine or F-alkyl group and their high flash points. Other merits of the fluorinated solvents include low viscosity, robust thermal stability, a wide liquid phase temperature range, and stability against lithium metal.

A wide variety of fluorinated organic solvents are viable according to this disclosure, including a fluorinated nitrile, a fluorinated carbonate, a fluorinated borate, a fluorinated ester, a fluorinated ether, a fluorinated sulfone, a fluorinated sulfide, a fluorinated acetal, a fluorinated phosphite, a fluorinated phosphate. In addition, the fluorinated solvent can include fluoroethylene carbonate, methyl trifluoroethyl carbonate, fluoroethyl methyl carbonate, bis(2,2,2-trifluoroethyl) carbonate (FDEC), 3,3,3-trifluoropropylene carbonate (TFPC), 2-trifluoromethyl-3-methoxyperfluoropentane, 1,1,2,2-tetrafluoroethyl 2,2,3,3-tetrafluoropropyl ether, 2-trifluoro-2-fluoro-3-difluoropropoxy-3-difluoro-4-fluoro-5-trifluoropentane (TPTP), 2-trifluoromethyl-3-methoxyperfluoropentane (TMMP), TFPC: 3,3,3-trifluoropropylene carbonate; FDEC: bis(2,2,2-trifluoroethyl) carbonate; FEPE: 1,1,2,2-tetrafluoroethyl 2,2,3,3-tetrafluoropropyl ether; TFEC: bis(2,2,2-trifluoroethyl) carbonate; FEMC: methyl (2,2,2-trifluoroethyl) carbonate, and FEC: fluoroethylene carbonate This includes all combinations and mixtures thereof.

Although a fluorinated solvent is preferred, it is possible to utilize other types of organic solvents such as nitriles, carbonates, borates, esters, ethers, sulfones, sulfides, acetals, phosphites, phosphates, or mixtures thereof. In this case, the organic phosphite solvent can be selected from a group consisting of tris(trialkylsilyl) phosphite, tris(trimethylsilyl) phosphite, tris(triethylsilyl) phosphite, tris(tripropylsilyl) phosphite, or a mixture thereof. An organic ester solvent can include γ-butyrolactone, ethyl acetate, ethyl propionate, methyl propionate, methyl butyrate, ethyl butyrate, propyl butyrate, butyl butyrate, 1,3-dioxolane, diglyme, hydrofluoroether, or a mixture thereof. Moreover, the organic sulfone solvent can include ethylmethyl sulfone, 2,2,2-trifluoroethylmethyl sulfone, ethyl-sec-butyl sulfone, or a mixture thereof. In addition, an organic carbonate solvent can include ethylene carbonate, propylene carbonate, dimethyl carbonate, diethyl carbonate, ethyl methyl carbonate, or a mixture thereof.

Another type of organic solvent suitable for the electrolyte materials is organosilicon-based solvents. In a preferred embodiment, the fluorinated solvent can be mixed with an organosilicon-based solvent. Preferred organosilicon-based solvents include, but are not limited to, 2,2-dimethyl-3,6,9-trioxa-2-siladecane, methyl (trimethylsilylmethyl) carbonate, ethyl (trimethylsilylmethyl) carbonate, 2,2-dimethyl-3,6,9-trioxa-2-siladecane, bis-(trimethylsilylmethyl) carbonate, 2,2-dimethyl-4,7,10,13-tetraoxa-2-silatetradecane, 2,2,4,4-tetramethyl-3,8,11,14,17-pentaoxa-2,4-disilaoctadecane, and mixtures thereof.

Another beneficial aspect of improving electrolyte functionality and performance is an additive. Preferably, this is in the form of a passivation layer called the solid electrolyte interphase (SEI) that is formed on electrode surfaces from the decomposition products of electrolytes. The SEI allows Li+ transport and blocks electrons in order to prevent further electrolyte decomposition and ensure continued electrochemical reactions. In addition, it is nonflammable and operational over a wide temperature range. Therefore, the SEI film-forming additives will help form a protective layer on the lithium anode in-situ to minimize electrolyte decomposition and mitigate lithium dendrite growth.

Therefore, the preferred additive forms a passivation film on the lithium metal anode (in-situ coating method). This additive can include lithium polysulfides (Li₂Sₓ, x=1 to 8), Li nitrate (LiNO₃), Phosphorous pentasulfide (P₂S₅), Cu acetate [Cu(CH₃COO)₂], lanthanum nitrate [La(NO₃)₃], VC: vinylene carbonate, TMSPi: tris(trimethylsilyl), phosphitearious; SN: succinonitrile, LIDFOB: Lithium difluoro (oxalato) borate; lithium polysulfides; methyl 2,2,2-trifluoroethyl ester; bis(hexafluoroisopropyl) carbonate; ethyl hexfluoroisopropyl carbonate; lithium 2-fluoro-4,5-dioxo-2-(perfluorophenyl)-1,3,2-dioxaborolan-2-uide; methyl ((2-oxo-1,3-dioxolan-4-yl)methyl) carbonate; lithium 3,9-diallyl-3,9-difluoro-2,4,8,10-tetraoxo-1,5,7,11-tetraoxa-6-boraspiro[5.5]undecan-6-uide; lithium [(3,6-diethoxyphosphoryl)-1,2-catecholato][oxalato]borate, tris (1,1,1,3,3,3-hexafluoro-2-propyl) phosphate, lithium perfluoro-tert-butoxide, and mixtures and combinations thereof.

A third component of the electrolyte is a lithium-ion electrolyte salt that is conductive, high voltage, and has a wide temperature range. This can include lithium hexafluorophosphate, lithium hexafluoroarsenate, lithium perchlorate, lithium tetrafluoroborate, lithium trifluoromethane sulfonate, lithium bis(fluorosulfonyl)imide, lithium bis(trifluoromethanesulfonyl)imide, lithium bis(pentafluoroethylsulfonyl)imide, lithium tris(trifluoromethylsulfonyl) methide, lithium trifluoro tris(pentafluoroethyl)phosphate, lithium bis(oxalato)borate, lithium hexafluoroisopropoxide, lithium malonate borate, lithium difluoro(oxalato) borate, lithium hexafluoroantimonate, LiPF₆, LiBF₄, LiN(CF₃SO₂)², (LiTFSI), lithium 4,5-dicyano-2-(trifluoromethyl)imidazol-1-ide, and lithium perfluoro-tert-butoxide. This includes all combinations and mixtures thereof.

Dual or multi-lithium salts are preferred since they will provide more desirable properties, including high lithium-ion (Li+) conductivity, high voltage stability, and a wide temperature range than a single lithium salt.

### EXAMPLES

Preferred embodiments of the invention are further defined in the following nonlimiting Examples. It should be understood that these Examples, while indicating certain embodiments of the invention, are given by way of illustration only. From the above discussion and these Examples, one skilled in the art can ascertain the essential characteristics of the invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Testing of Li/Ni-Rich System with High Voltage Electrolyte and Fluorinated Solvents

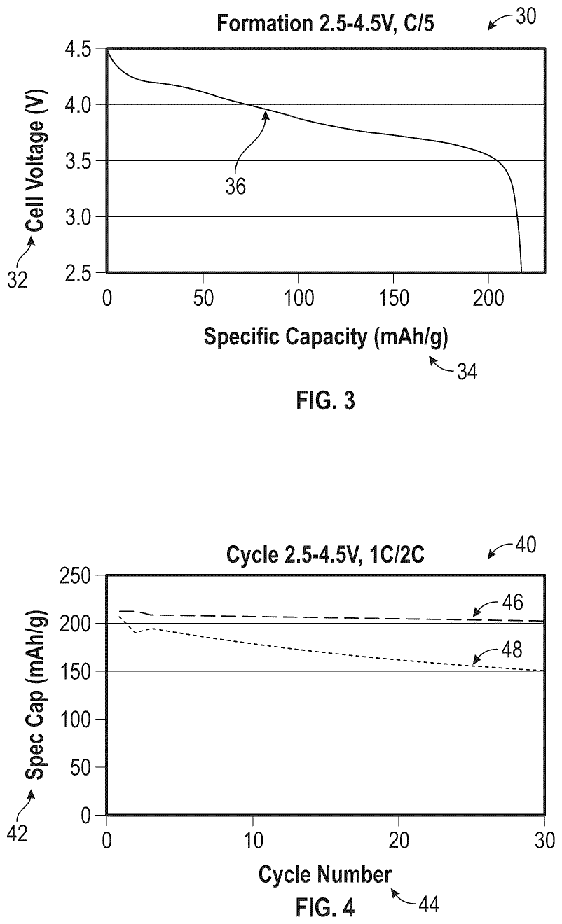

A preliminary investigation in Li/Ni-rich system where a high voltage electrolyte with fluorinated solvents and additives was formulated. The high voltage stable electrolyte enabled a high specific capacity of 220 milliampere hours per gram mass (mAH/g) in Li/NMC811 cells when charged to 4.5 V at C/5. Referring now to FIG. 3, the graphical representation 30 of cell voltage in volts 32 versus specific capacity in milliampere hours per gram mass (mAH/g) 34 is indicated by the numeral 36. This provides a projected specific energy that is greater than or equal to 600 Watt-hours per kilogram (Wh/kg) at the cell level.

Referring now to FIG. 4, there is a graph 40 of the specific capacity 42 that is defined as the amount of electric charge (“milliampere hours” or mAh) the material can deliver per gram of material versus the number of cycles 44. This is when subjected to high voltage and high current C rate, i.e., 1 C charge and 2 C discharge, cycling, the high voltage electrolyte of this disclosure is indicated by numeral 46 provides a substantially improved cycle stability of the Li/NMC811 cells, compared with a baseline electrolyte indicated by numeral 48. These results make Li/Ni-rich (NMC811) battery technology very viable.

### Example 2

Testing of Fluorinated Solvents with Li Metal Anode/NMC811 Cathode Battery Cells

In this experiment, a fluorinated-solvent-based, high-voltage stable electrolyte (hereinafter “HVE”) was developed and evaluated in Li metal anode/NMC811 cathode (Li/NMC811) battery cells, and lithium metal were used as the cathode and anode, respectively, with cathode-based lithium batteries. Li/NMC811 cells with a cathode that has greater than 80% nickel utilizing HVE exhibited a superior long-term cycle performance stability, maintaining ˜80% capacity retention after ˜500 cycles when cycled at a high cut-off voltage of 4.5 V (vs. Li). In contrast, Li/NMC811 cells with a carbonate solvent-based, conventional Li-ion battery electrolyte (baseline electrolyte, hereinafter “BE”) experienced a large capacity fade with only about a 15% capacity retention at around 500 cycles. The superior cycle stability of the Li/NMC811 cells with the high-voltage electrolyte is attributed to the inherently high-voltage stable, fluorinated solvent-based electrolyte. Furthermore, the cycling data are supported by various physical and electrochemical characterizations and the density functional theory modeling where the HVE shows much less tendency of deprotonation than the BE electrolyte. The findings presented in this experiment are important to help tackle the technical challenges facing nickel-rich-based lithium batteries to realize their high energy density potentials while having a long-lasting battery life.

Among liquid solvents, fluorinated solvents have shown unique properties of wide electrochemical windows, low viscosity, robust thermal stability, wide liquid phase temperatures, and good stability toward lithium metal anodes. In particular, fluorinated-solvent-based electrolytes are more resistant to oxidation from high-voltage cathodes such as NMC811 (HOMO of fluorinated-solvent-based electrolytes <μ_{c}) due to the strong electron-withdrawing effect of F-alkyl groups in the fluorinated solvents than the carbonate-solvent-based electrolytes with O-alkyl groups (HOMO of carbonate-solvent-based electrolytes >μ_{c}).

Lithium salt also plays a key role in achieving oxidative stability, low volatility, and nonflammability in electrolytes. Therefore, it is preferable to use low-cost lithium salts with high ionic conductivity and low viscosity. Previous studies have shown that the commonly used lithium salt, hexafluorophosphate (LiPF₆), is prone to hydrolysis to produce reactive species (hydrogen fluoride) even in the presence of trace amounts of water, which is responsible for the dissolution and migration of transition metals in nickel-rich cathodes.

Nickel-rich cathodes were prepared by ball milling 90 wt % NMC811, 3 wt % Super-P, 2 wt % carbon nanotubes, and 5 wt % polyvinylidene fluoride (PVDF) binder in N-methyl-2-pyrrolidone. The cathode slurry was coated on aluminum foil using a doctor blade and dried at 60° C. in a vacuum overnight. The dried cathode electrodes were cut into twelve-millimeter diameter disks with an active material loading of ˜5 mg/cm².

The HVE was prepared by dissolving 1.0M LiTFSI and 0.1 M LiDFOB in fluoroethylene carbonate, bis(2,2,2-trifluoroethyl) carbonate, and methyl (2,2,2-trifluoroethyl) carbonate with FEC/FDEC/FEMC of 1:1:1 volume %. A baseline electrolyte (BE), consisting of 1M LiPF₆ in ethylene carbonate (EC) and dimethyl carbonate (DMC) with EC: DMC of 1:1 vol %, was used as a control electrolyte.

A scanning electron microscopy (SEM) imaging was used to evaluate the cathode morphologies after extended cycling. The electrochemical performance of Li/NMC811 with HVE and BE was evaluated using CR2032 coin cell hardware with a membrane as separators and lithium metal disks as anodes. Typically, ˜100 μL electrolyte was added per coin cell. The coin cells were assembled in a glove box under an argon atmosphere with both the H₂O and O₂ content kept below 0.1 ppm. The coin cells were galvanostatically charged and discharged with a battery testing system between 2.5-4.5 V at a 0.25 C rate for the initial five cycles and at a 1 C rate for the extended cycles.

To evaluate lithiation/delithiation potential of the Li/NMC811 coin cells, cyclic voltammetry (CV) profiles were obtained using a potentiostat/galvanostat electrochemical workstation at a scan rate of 0.05 mVs⁻¹. Electrochemical Impedance Spectroscopy (EIS) spectra of the Li/NMC811 coin cells were collected with the CS unit at a frequency range of 1 MHz to 0.01 Hz and an AC voltage of 10 mV. Li∥Li symmetric cells were assembled with two lithium chips separated by a separator using 100 mL of respective electrolyte cycled for 24 minutes at 5 mA cm⁻². Linear sweep voltammetry (LSV) of the HVE and BE electrolytes (600 mL) were investigated using a workstation within a voltage window of 3.0-5.5 V vs. a lithium reference electrode at a scan rate of 5 mVs⁻¹. The workstation was connected with a low-volume cell kit where lithium metal, platinum wire, and platinum electrode with a diameter of three millimeters were used as a reference electrode, a counter electrode, and a working electrode, respectively. Both the workstation and the low-volume cell kit were kept in the argon-filled glove box, and the data was collected on a computer via a Bluetooth connection.

Density Function Theory (DFT) was used to conduct a chemical analysis of components in HVE and how they interact with the NMC811. The calculation was performed using the supercell models and a simulation package.

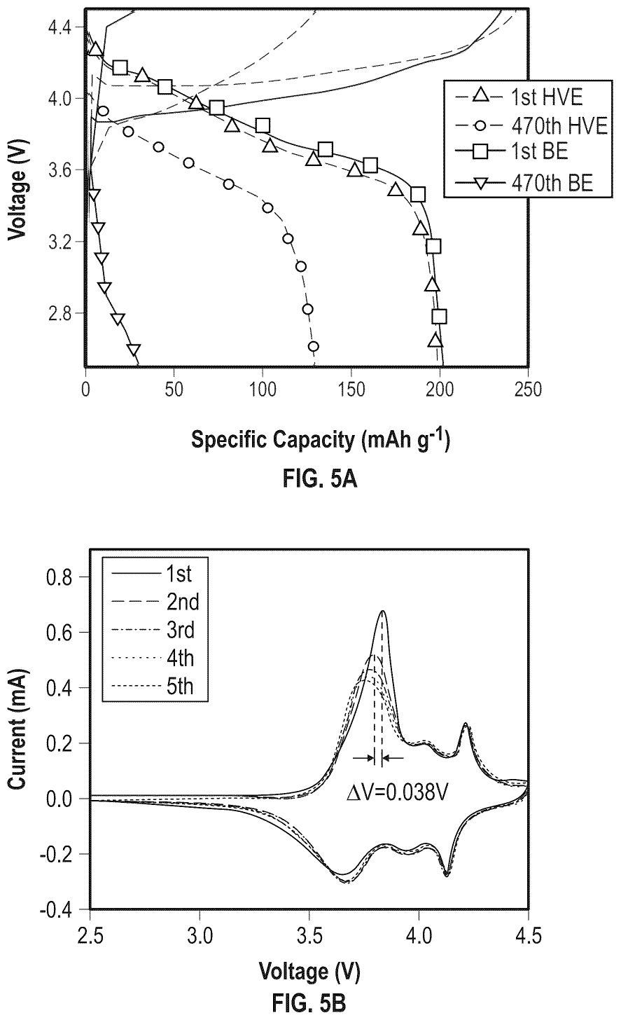

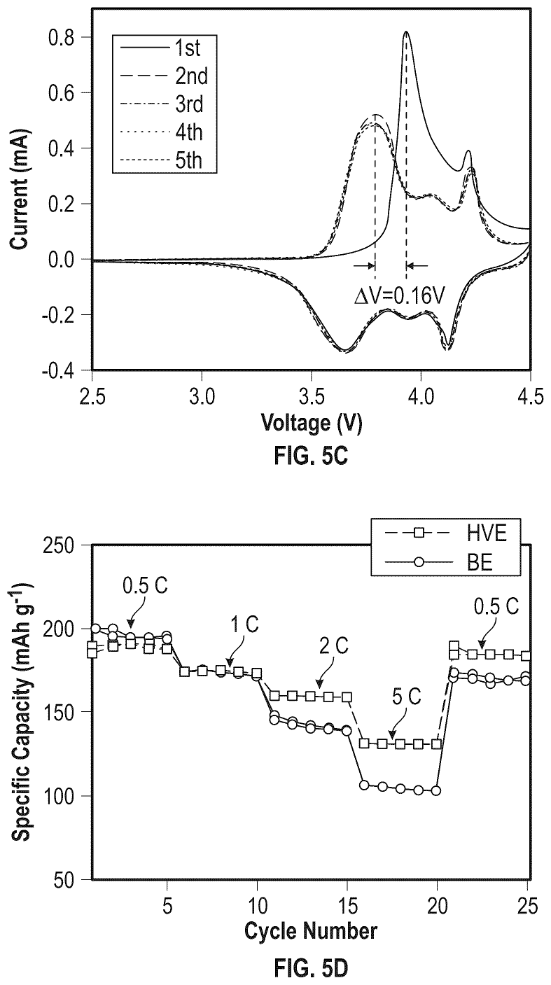

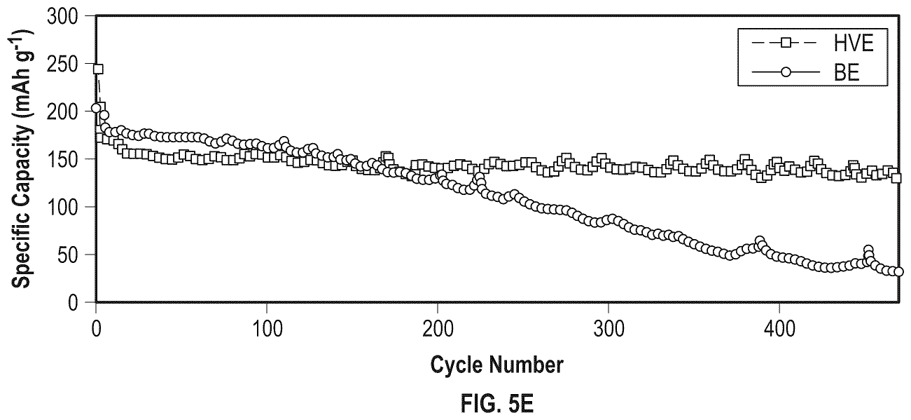

Referring now to FIG. 5A shows charge/discharge voltage profiles of the coin cells at the first and 470th cycles, respectively. Both the HVE- and the BE-based Li/NMC811 cells delivered a specific discharge capacity of ˜200 mAh g⁻¹ at the first discharge.

Referring now to FIG. 5B and FIG. 5C, CV profiles of the HVE- and BE-based cells, respectively, are shown. In both graphs, oxidation, and reduction peaks from 3.6 to 4.2 V are assigned to phase transformation in NMC811. Specifically, the oxidations peaks around 3.8 V, 4.0 V, and 4.2 V correspond to the first layered hexagonal (H₁) to monoclinic (M), then from M to the second hexagonal (H₂), and finally from H₂ to the third hexagonal (H₃) phase transition, respectively. The HVE-based cell showed a much smaller voltage polarization than the BE-based cell near 3.8 V between the 1^{st} and the 2^{nd} oxidations peaks (ΔV=0.04 V vs. 0.16 V) This is shown by the comparison between FIG. 5B and FIG. 5C, which indicates a reduced structural transformation of NMC811 in the HVE cell than in the BE cell. Moreover, during the first charge, the HVE-based cell showed three oxidation peaks around 3.8 V, 4.0 V, and 4.2 V.

In contrast, the BE-based cell showed only two oxidation peaks on the first charge, possibly due to interference from the oxidation side reactions on the surface of the NMC811 cathode. The HVE and BE-based cells showed similar reduction peaks. These findings suggest that the fluorinated high-voltage electrolyte suppressed the phase transformations and reduced side reactions on the NMC811/electrolyte interface with smaller interfacial polarization. These effects helped improve the cycle stability of the HVE-based Li/NMC811 cells.

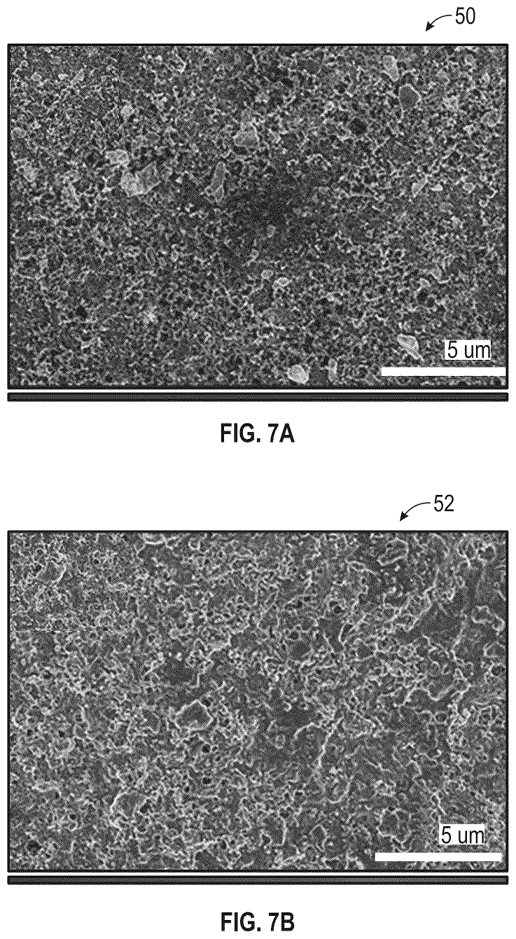

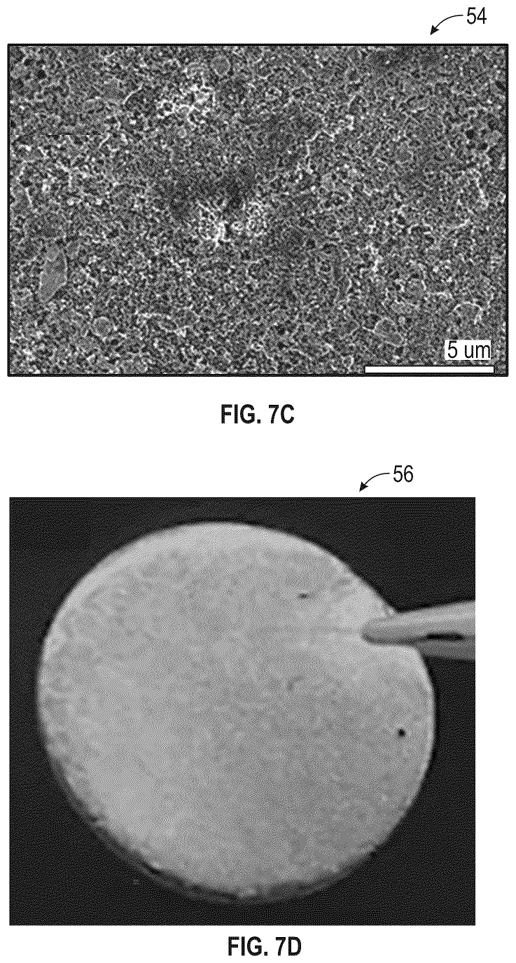

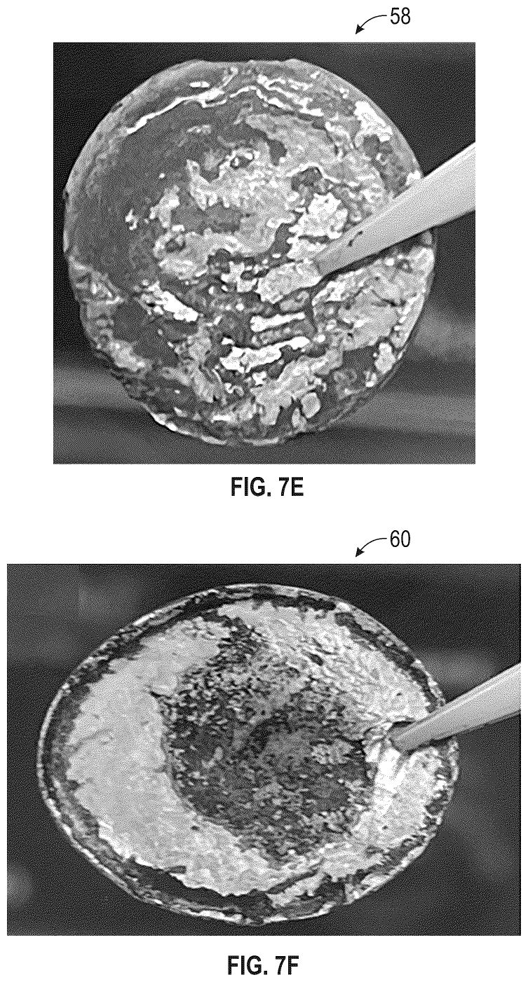

FIG. 5D shows rate capability test results for Li/NMC811 cells with HVE and BE electrolytes. The HVE-based cell delivered specific capacities of 190 mAh g⁻¹, 174 mAh g⁻¹, 159 mAh g⁻¹, and 130 mAh g⁻¹ at 0.5, 1, 2, and 5 C-rate, respectively. This corresponds to the C-rate capacity retention of 92%, 84%, and 68% at 1 C, 2 C, and 5 C vs. 0.5 C. In addition, the HVE-based cell recovered a specific capacity of 184 mAh g⁻¹ (97%) after switching back to 0.5 C. On the other hand, the BE-based cell delivered specific capacities of 194 mAh g⁻¹, 157 mAh g⁻¹, 142 mAh g⁻¹, and 104 mAh g⁻¹ at 0.5 C, 1 C, 2 C, and 5 C-rate, respectively. This corresponds to 81%, 73%, and 54% C-rate capacity retention at 1, 2, and 5 C vs. 0.5 C. To assess the impact of the rate test on performance, the cells were cycled at 0.5 C after the completion of the rate test. The BE-based cell recovered a smaller specific capacity of 168 mAh g⁻¹ (87%) compared with the HVE-based cell of 97%, after switching back to 0.5 C. This quick deterioration of the BE-based cell, even after a few C-rate test cycles, is possibly due to an increase of interfacial resistance as a result of the breakage and reforming of the SEI layer at the lithium anode surface during the high-rate discharge. The rate capability test results show that the fluorinated-solvent-based electrolyte provided not only superior cycle stability but also higher rate capability, due possibly to the more robust SEI layer at the lithium anode surface (see FIG. 7D-F), to the resultant Li/NMC811 cells than the BE electrolyte.

FIG. 5E shows extended cycle life performance (specific capacity vs. cycle number) for Li/NMC811 cells with HVE and BE electrolytes. The cells were cycled between 2.5-4.5 V at a 1 C rate at room temperature. The HVE-based Li/NMC811 cell showed a stable cycle performance with a specific discharge capacity of 129 mAh g⁻¹, corresponding to a 77% capacity retention, after 470 cycles. In contrast, the BE-based Li/NMC811 cell experienced a fast capacity fade upon cycling with a specific discharge capacity of 30 mAh g⁻¹, corresponding to a 16% capacity retention, after 470 cycles. The superior cycle stability exhibited by the HVE-based cell is attributed to reduced oxidative and reductive side reactions at the electrolyte/NMC811 cathode and the electrolyte/lithium anode interfaces, respectively, afforded by the high-voltage electrolyte when the Li/NMC811 cells were cycled with a high charge cut-off voltage of 4.5 V.

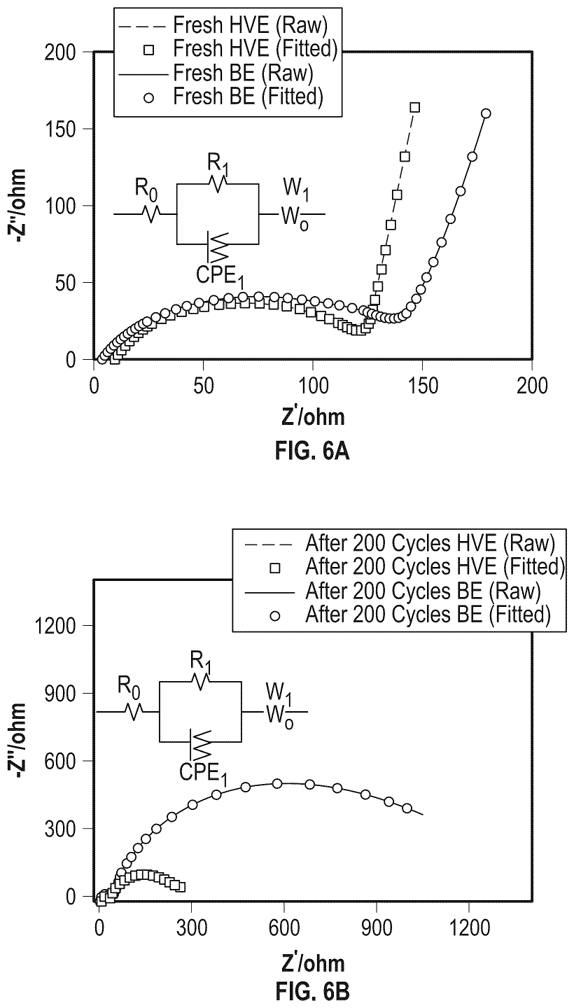

Referring now to FIG. 6A and FIG. 6B, further investigation of the degradation mechanism of the NMC811 cathode, utilizing EIS measurements, was conducted for fresh and cycled Li/NMC811 cells with HEV and BE electrolytes. The cells were in a fully charged state when undergoing the EIS measurements. To help EIS analysis, an equivalent circuit, R₀+CPE₁∥R₁+W, was used to fit the EIS spectra as shown in FIG. 6A for fresh and FIG. 6B for cycled, where R₀ is bulk resistance, R₁ is charge transfer resistance, CPE stands for constant phase element, the symbol ∥ represents parallel circuit, CPE∥R₁ represents interfacial impedance, and W is Warburg (mass transfer) impedance at low frequencies. The fitting parameters are shown in Table 2 below. The EIS data showed that, after 200 cycles, the HVE-based Li/NMC811 cell had four times lower charge transfer resistance (R₁=311Ω) compared to the BE-based cell (R₁=1384Ω). This indicates that the HVE electrolyte helped suppress the decomposition of the electrolyte on the surface of the NMC811 cathode after the extended cycles. On the other hand, the conventional carbonate-solvent-based BE electrolyte deprotonates are faster as compared to HVE (see DFT analysis further below). The EIS results suggest that the fluorinated-solvent-based electrolyte plays an important role in suppressing the side reactions on the surface of the NMC811 cathode.

TABLE 2
EIS Fitting Parameters for Li/NMC-811
Cells with HVE and BE Electrolytes

| EIS fitting parameters | R₀ (Ω) | R₁ (Ω) |
|---|---|---|
| Fresh HVE | 4.7 | 139 |
| Fresh Baseline | 1.2 | 175 |
| After 200 cycles HVE | 14.9 | 311 |
| After 200 cycles Baseline | 6.0 6.0 1384 [symbol] | 6.0 1384 1384 [symbol] 6.0 [symbol] |

[symbol]

indicates data missing or illegible when filed

Referring now to FIG. 7A through FIG. 7C, which show SEM images of NMC811 cathodes: pristine 50 in FIG. 7A, after 200 cycles with BE electrolyte 52 in FIG. 7B, and after 200 cycles with HVE electrolyte 54 in FIG. 7C, respectively. It can be seen that the NMC811 cathode, as shown in FIG. 7B, harvested from the BE-based Li/NMC811 cell, shows some surface deposits after 200 cycles, likely due to side reactions on the BE electrolyte/NMC811 cathode interface during cycling. The surface morphology of the NMC811 cathode, shown by numeral 54 in FIG. 7C, harvested from the HVE-based Li/NMC811 cell is similar to the pristine cathode after 200 cycles, due to suppressed side reactions on the surface of the cathode.

Referring now to FIG. 7D through FIG. 7F, which show digital photographs of lithium-ion metal anode disks as pristine 56 in FIG. 7D, after 200 cycles with the BE electrolyte 58 in FIG. 7E, and after 200 cycles with HVE electrolyte 60 in FIG. 7F. The surface morphology of the lithium anode disk, shown in FIG. 7F is harvested from the HVE-based Li/NMC811 cell, shows less fragmentation than the lithium anode disk, shown in FIG. 7E and indicated by numeral 58, harvested from the BE-based Li/NMC811 cell. The BE-based lithium anode exhibits visible islands/fragmented surface features after 200 cycles.

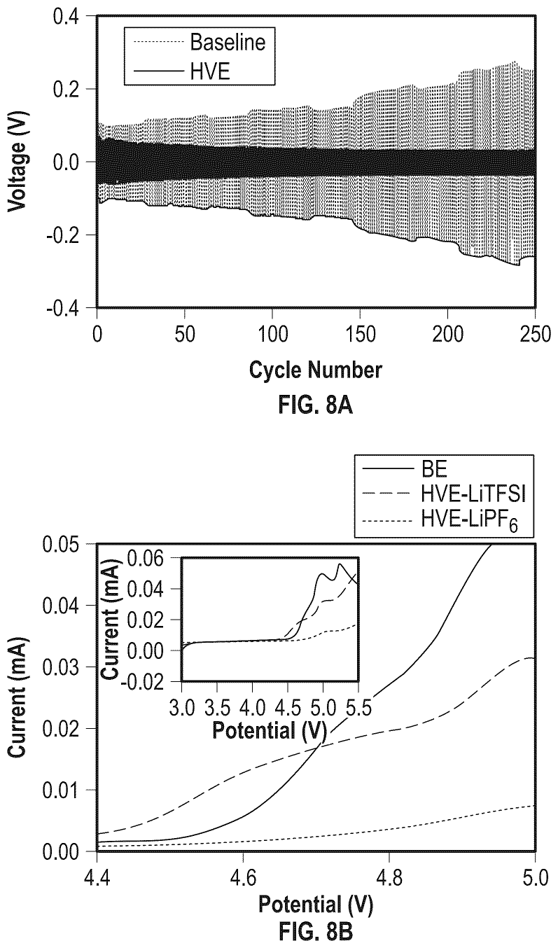

Referring now to FIG. 8A, there is a voltage versus cycle number for Li∥Li symmetric cells with HVE and BE electrolytes at 5 mA cm⁻². The Li∥Li cell with HVE showed a stable stripping/plating behavior with a nearly constant overpotential of up to 250 cycles. In contrast, the Li∥Li cell with BE exhibited a large and continuously growing overpotential vs. cycling. The superior Li stripping/plating stability of the Li∥Li cell with HVE is attributed to the formation of a dense and robust solid electrolyte interface (SEI) layer, e.g., LiF, on the lithium surface, which protects the lithium metal from reductive side reactions and facilitates a smooth lithium stripping/plating. This result is well aligned with the digital photographs of the lithium metals.

Referring now to FIG. 8B, there is an oxidative LSV scans for different electrolytes, where HVE-LiTFSI and HVE-LiPF₆ represent the type of lithium salt used in otherwise the HVE electrolyte components. The HVE-LiTFSI, BE, and HVE-LiPF₆ showed an oxidation onset potential (in contrast to a lithium reference electrode) of 4.4 V, 4.5 V, and 4.7 V, respectively. Clearly the oxidation onset potential depended on the type of lithium salt used. The lower oxidation onset potential (4.4 V vs. Li) of HVE-LiTFSI is attributed to the lower oxidation stability of the TFSI⁻¹ anions compared with the PF₆⁻¹ anions. Indeed, HVE-LiPF₆ showed higher oxidation onset potential (4.7 V vs. Li) and much smaller oxidation current than that of the BE electrolyte, which suggests that the fluorinated solvents used in the HVE are inherently more stable, i.e., HOMO of HVE<μ_{c} of NMC811, than the carbonate solvents (EC, DMC) used in the BE electrolyte, i.e., HOMO of BE>μ_{c} of NMC811. The electrolyte LSV data, as shown in FIG. 8B, and the electrochemical performance data, as shown in FIG. 6A and FIG. 6B, suggest that solvent stability played a vital role in the cycle stability of the Li/NMC811 cells, which is supported by other analytical and electrochemical data presented above.

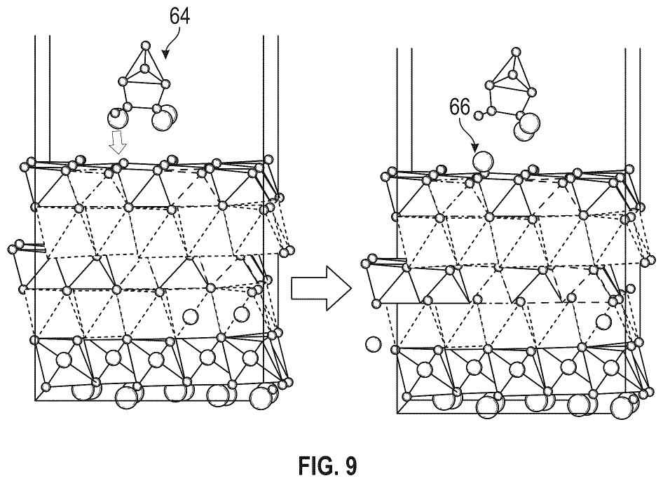

Referring now to FIG. 9, when comparing the protonation tendency of HVE electrolyte components (FEC, FEMC, FDEC) and the prototypical BE electrolyte components (EC, DMC) using the first principles DFT calculations are shown. For comparison, the energy difference as computed, ΔE, between the configuration with physio adsorbed molecule on the top bare NMC811 surface and the configuration with the deprotonated molecule on the top bare NMC811 surface. The results in Table 3 below show that the protonation tendency of the HVE electrolyte components is positive, while that of the BE electrolyte components is negative. This suggests that the BE electrolyte components deprotonate spontaneously while the HVE electrolyte components remain stable. Deprotonation may play a role in modifying the surface or growth of the interphase. The reactivity of added molecule (FDEC, FEC, FEMC, DMC), and EC.) and NMC811 (001) surface from PBE+μDFT calculations is represented on a physisorbed molecule on NMC811 surface where an FEC molecule is shown as an example by numeral 64 in FIG. 9. H transferred from the molecule to the NMC811 surface is shown by the numeral 66 in FIG. 9. The small arrow shows the movement of H, and the large arrow shows the configuration after the H transfer.

TABLE 3
Energy Difference Between Configuration with a Physio-adsorbed
Molecule on the top of NMC811 and Configuration with a Deprotonated
Physio-adsorbed Molecule on the top of NMC811

| ΔE | NMC811 (eV) |
|---|---|
| FDEC | 1.0 |
| FEMC | 1.1 |
| FEC | 1.0 |
| DMC | −1.2 |
| EC | −0.7 |

Therefore, a fluorinated-solvent-based, high-voltage stable electrolyte (HVE) is developed and evaluated in Li/NMC811 battery cells. As a result, Li/NMC811 cells with HVE exhibit a superior long-term cycle performance stability, maintaining ˜80% capacity retention after ˜500 cycles when cycled at a high upper cut-off voltage of 4.5 V (vs. Li anode). In contrast, Li/NMC811 cells with a carbonate solvent-based, conventional lithium-ion battery electrolyte (BE) experienced a large capacity fade with only ˜16% capacity retention after ˜500 cycles. The superior cycle stability of the Li/NMC811 cells with the high-voltage electrolyte is attributed mainly to the capability of the HVE to protect the surface of the cathode from oxidation side reactions, suppress the reductive side reactions at the lithium anode, and facilitate smooth lithium stripping/plating during charge/discharge cycles. The cycling data are supported by various physical and electrochemical characterizations and the DFT modeling where the HVE shows much less tendency of deprotonation than the BE electrolyte.

This disclosure provides a powerful way to address the technical challenges facing Li/Ni-rich cathode-based lithium batteries to realize high energy density potential while providing long-lasting battery life.

From the foregoing, it can be seen that the present disclosure accomplishes at least all of the stated objectives.

### Example 3

### Cathode and Electrolyte Preparation

NMC811 cathodes were prepared by ball milling 90 wt % NMC811, 3 wt % Super-P, 2 wt % carbon nanotubes, 5 wt % polyvinylidene fluoride (PVDF) binder in N-methyl-2-pyrrolidone. The slurry was spread on carbon-coated aluminum foil and coated with the doctor's blade. The coated aluminum foil was placed in a vacuum oven at 80° C. overnight and punched into 12 mm diameter disks with active material loading of ˜5.0 mg/cm² to use as cathodes in Li-ion batteries.

The single-solvent electrolytes were prepared by mixing 1.0 M Lithium bis(trifluoromethanesulfonyl)imide (LiTFSI) and 0.1 M Lithium difluoro (oxalate) borate (LiDFOB) separately in different organic solvents as tabulated in Table 4. The organic solvents used were fluoroethylene carbonate (FEC), bis(2,2,2-trifluoroethyl) carbonate (FDEC), 3,3,3-trifluoropropylene carbonate (TFPC), Methyl (trimethylsilylmethyl) carbonate (MTMSMC), Ethyl (trimethylsilylmethyl) carbonate (ETMSMC), 2,2-dimethyl-3,6,9-trioxa-2-siladecane (1NM2) and Methyl (2,2,2-trifluoroethyl) carbonate (FEMC). The chemical structure of the organic solvents is shown in FIG. 20.

TABLE 4
Formulations of Single Solvent Electrolytes

| | |
|---|---|
| FEC | 1M LiTFSI and 0.1M of LiDFOB in FEC |
| FDEC | 1M LiTFSI and 0.1M of LiDFOB in FDEC |
| TFPC | 1M LiTFSI and 0.1M of LiDFOB in TFPC |
| MTMSMC | 1M LiTFSI and 0.1M of LiDFOB in MTMSMC |
| ETMSMC | 1M LiTFSI and 0.1M of LiDFOB in ETMSMC |
| 1NM2 | 1M LiTFSI and 0.1M of LiDFOB in 1NM2 |
| FEMC | 1M LiTFSI and 0.1M of LiDFOB in FEMC |

The co-solvent electrolytes were prepared by mixing 1M LiTFSI and 0.1M LiDFOB in a mixture of FEC and an organic solvent (1:1 vol %), as tabulated in Table 5. The organic solvents used were FDEC, TFPC, MTMSMC, ETMSMC, 1NM2, and FEMC.

TABLE 5
Formulations of Co-solvents Electrolytes

| | |
|---|---|
| FEC, TFPC | 1M LiTFSI and 0.1M of LiDFOB in FEC:TFPC (1:1 vol %) |
| FEC, MTMSMC | 1M LiTFSI and 0.1M of LiDFOB in FEC:MTMSMC (1:1 vol %) |
| FEC, FEMC | 1M LiTFSI and 0.1M of LiDFOB in FEC:FEMC (1:1 vol %) |
| FEC, 1NM2 | 1M LiTFSI and 0.1M of LiDFOB in FEC:1NM2 (1:1 vol %) |
| FEC, ETMSMC | 1M LiTFSI and 0.1M of LiDFOB in FEC:ETMSMC (1:1 vol %) |
| FEC, FDEC | 1M LiTFSI and 0.1M of LiDFOB in FEC:FDEC (1:1 vol %) |

### Example 4

### Physical and Electrochemical Characterizations

The electrochemical performance of Li/NMC811 cells with single-solvent and co-solvent electrolytes was evaluated using CR2032 coin cell hardware with Celgard 2320 membrane as separators and lithium metal disks as anodes. Typically, ˜100 μL electrolyte was added per coin cell. The coin cells were assembled in a glove box under an argon atmosphere with the H₂O and O₂ content below 0.1 ppm. The coin cells were galvanostatically charged and discharged with a battery testing system between 2.5-4.5 V at 0.25 C-rate for the initial five cycles and 1.0 C-rate for the rest of 200 cycles.

Cyclic voltammetry (CV) profiles were obtained using a potentiostat/galvanostat electrochemical workstation at a scan rate of 0.05 mVs⁻¹ to evaluate the lithiation/delithiation potential of the Li/NMC811 coin cells.

Electrochemical Impedance Spectroscopy (EIS) spectra of the Li/NMC811 coin cells were collected with the potentiostat/galvanostat electrochemical workstation with a frequency range of 1 MHz to 0.01 Hz and an A.C. voltage of 10 mV.

Linear sweep voltammetry (LSV) of the single-solvent and co-solvent electrolyte were investigated using a PalmSens4 workstation within a voltage window of 3.0-5.5 V vs. a Li reference electrode at a scan rate of 5 mVs⁻¹. PalmsSens4 was connected with a low-volume cell kit containing 600 μL of electrolyte, where lithium metal, platinum wire, and platinum electrodes with a diameter of 3 mm were used as reference, counter, and working electrodes, respectively. The PalmsSens4 workstation and the low-volume cell kit were kept in the Argon-filled glove box, and the data was collected on a computer remotely via Bluetooth.

Li∥Li symmetric cells were assembled in CR2032 coin cell hardware with two 1.0 mm lithium chips separated by a separator, 100 μL of fluorinated electrolyte per cell. The Li∥Li symmetric cells were firstly activated by keeping at rest for 6 hours then were cycled with the battery testing system unit at 3 mA cm⁻² with 30 minutes plating/stripping time, respectively at room temperature.

NMC811∥NMC811 symmetric cell was prepared in two steps. Two coin cells were made using CR2032 coin cell hardware with Celgard 2320 membrane as separators, lithium metal disks as anodes, and NMC811 as cathode. Typically, ˜100 μL fluorinated electrolyte was added per coin cell. The coin cells were assembled in a glove box under an argon atmosphere with the H₂O and O₂ content below 0.1 ppm. The coin cells were galvanostatically charged and discharged with a battery testing system between 2.5-4.5 V at 0.25 C-rate for the initial cycle and only charged between 2.5-4.3 V at 0.05 C-rate for the second cycle. In the second step, two charged NMC811 cathodes were then disassembled, and NMC811∥NMC811 symmetric cells were then prepared in CR2016 coin cell hardware with two charged NMC811 cathodes separated by a separator, 100 μL of similar fluorinated electrolyte used at the charging stage was used per symmetric cell. The NMC811∥NMC811 symmetric cells were first activated by keeping at rest for 6 hours and then were cycled with the battery testing system unit at 3 mA cm⁻² with 5 minutes intercalation/deintercalation time, respectively at room temperature.

X-ray photoelectron spectroscopy with monochromatized Al Kα radiation (hv=1486.6 eV) was used to study the chemical state of the NMC811 cathode before and after electrochemical cycles. The XPS is directly attached to a glovebox to avoid sample exposure to air.

### Example 5

### Density Functional Theory Modeling

Density Functional Theory (DFT) was performed with a software package for performing ab initio quantum mechanical calculations. The NMC811 supercell was constructed with the R3m space group where Li, O, and the transition metals (TMs) occupy the 3b, 6c, and 3a sites, respectively. A total of 120 atoms were contained in each NMC811 supercell. Projector-augmented wave (PAW) potentials were used to mimic the ionic cores; at the same time, the generalized gradient approximation (GGA) in the Perdew-Burke-Ernzerhof (PBE) was employed for the exchange and correlation functions. To model onsite Coulombic repulsion between localized electrons in the transition metal 3d electronic states, the DFT+U method with Hubbard U-J values of 6.7 eV, 4.2 eV, and 4.91 eV for Ni, Mn, and Co was adopted. The plane-wave set was expanded within an energy cutoff of 340 eV. The 4×2×1 mesh of k points in the Monkhorst-Pack scheme was chosen for the Brillouin zone sampling. Energy optimization was considered complete when the energy difference between two subsequent iterations was less than 104 eV.

Li slabs contained 72 atoms; which was constructed as 2×4×3 supercell of orthorhombic (111) surface slab (a₁=u₁+u₂ and a₂=−u₁+u₂, where u₁ and u₂ are surface unit vectors) of α-Li. The molecular structure of FEC was taken from a chemical structure database. Molecular structure of TFPC, FDEC FEMC, ETMSMC and MTMSMC were built using an atomic-scale modeling software molecule builder.

The molecules were physiosorbed into the Li-slab and NMC slabs. The distance between the molecule and underlying slab was minimized using conjugate gradient methods.

### Example 6

### Initial Voltage Profiles

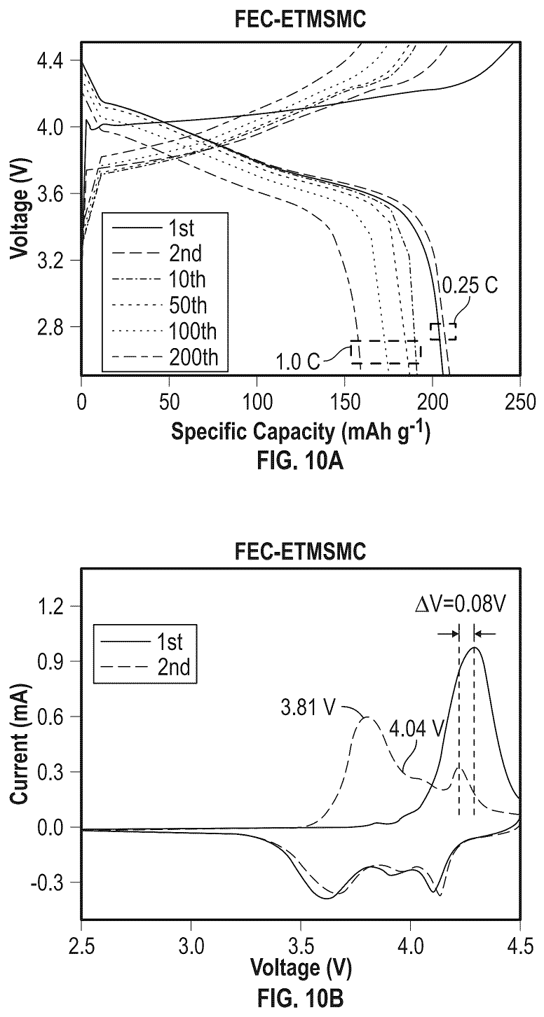

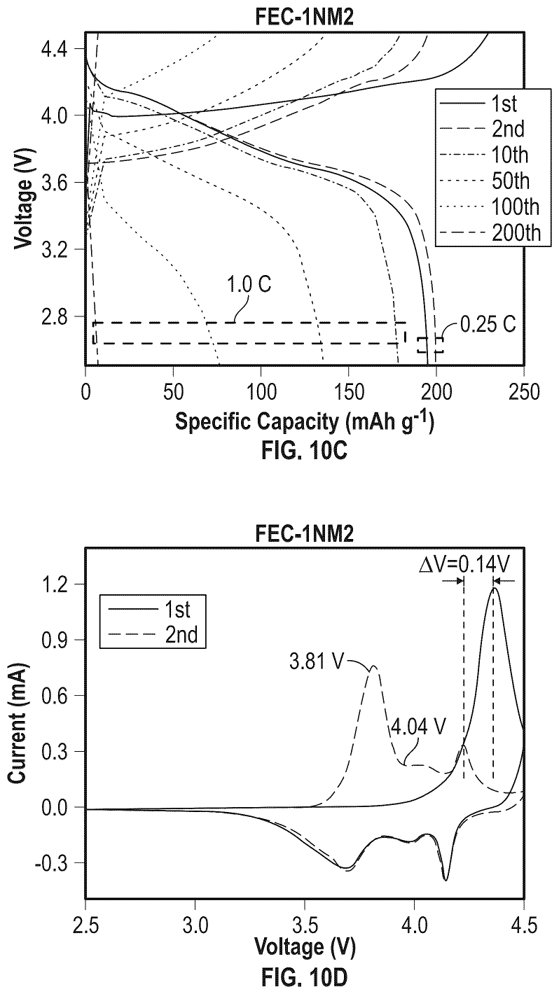

FIGS. 10A and 10B show the charge/discharge voltage profiles and the CV profiles, respectively, of Li/NMC811 cell with FEC-ETMSMC, the best performing co-solvent electrolyte. Without being limited by theory, it is believed that introducing FEC into the ETMSMC electrolyte resulted in the benefits of suppressing the phase transformations and reducing side reactions at the NMC811/electrolyte interface and thus resulted in a more negligible interfacial polarization. These benefits led to an improved cycle stability of the FEC-ETMSMC-based Li/NMC811 cells as shown in FIG. 10A. In FIG. 10B, the oxidation and reduction peaks from ˜3.6 to ˜4.3 V are assigned to phase transformations in the NMC811 cathode. FIG. 10B shows the oxidation peaks around 3.8 V, 4.0 V, and 4.2 V which respectively correspond to the first layered hexagonal (H1) to monoclinic (M), M to the second hexagonal (H2), and finally H2 to the third hexagonal (H3) phase transition.

For comparison, FIGS. 10C and 10D show the unstable voltage and CV profiles of the worst performing electrolyte, FEC-1NM2. Although the CV profiles of the FEC-ETMSMC and FEC-1NM2-based cells showed similar reduction peaks, the FEC-ETMSMC-based cell exhibited much smaller voltage polarization than the FEC-1NM2-based cell near 3.8 V between the 1st and 2nd oxidation peaks (ΔV=0.04 V vs. 0.16 V, FIG. 10B vs. FIG. 10D). This smaller voltage polarization indicates a reduced structural transformation of NMC811 in the FEC-ETMSMC cell compared to the FEC-1NM2 cell.

### Example 7

### Single Solvent Performance

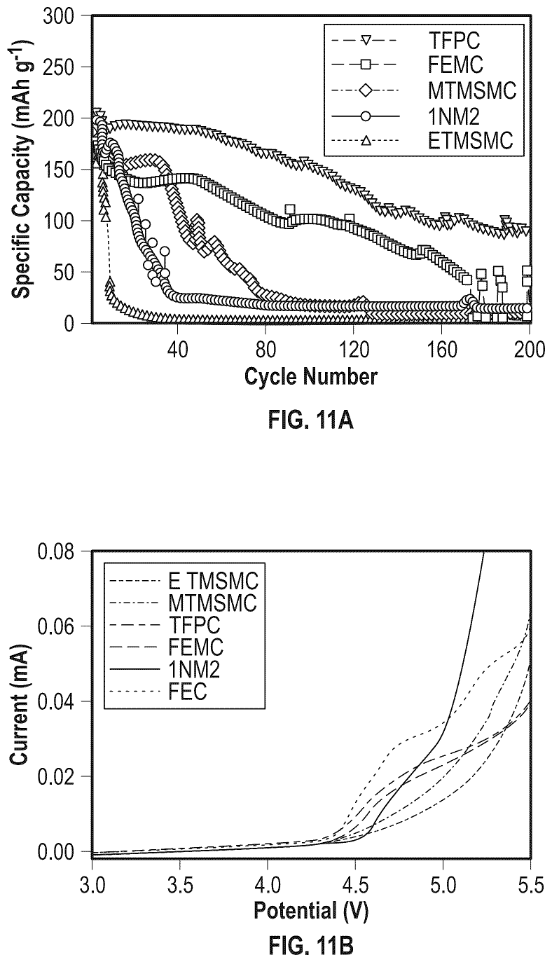

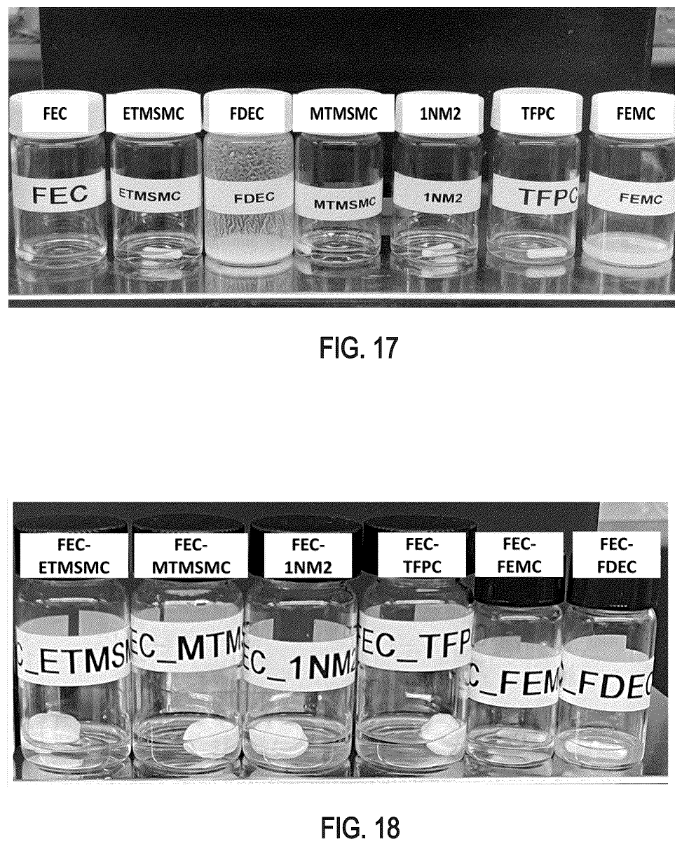

FIG. 17 shows the visual solubility of the single solvent electrolyte, which shows that LiTFSI and LiDFOB solutes are well dissolved in all the single solvents except FDEC. Out of all the combinations of single solvents, only FEMC exhibits a milky appearance, even though the additives and salt are thoroughly dissolved. FIG. 11A shows the cycling performance plots of NMC811 cathodes with each single solvent. Poor cycling performance is demonstrated by all the single solvents except for TFPC and FEMC electrolyte which contain carbonated solvents with a C—F3 group and performed relatively better than the organosilicon-carbonated and ether groups. Moreover, FIG. 11B shows the plots from the linear sweep voltammetry (LSV) test, and all of the single solvents' oxidation onset potentials are either marginally below or above 4.5 volts, which is the maximum voltage of the Li/NMC811 cells. Thus, single-solvent electrolytes exhibited oxidative stability up to 4.5V (vs. Li) according to their oxidative LSV scan.

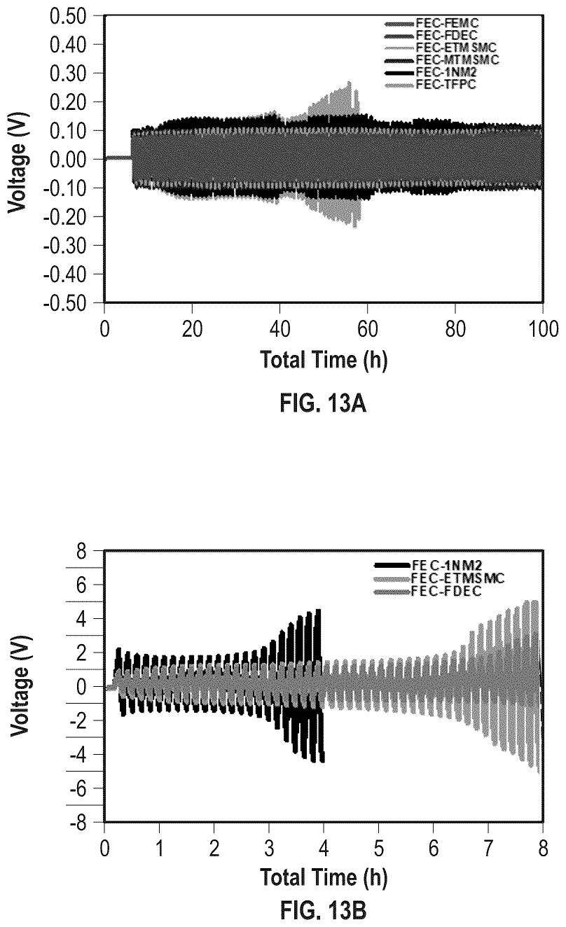

The cycling performance test excluded the performance curve for FEC, as the FEC-based cell exhibited zero performance. The compatibility of the single solvent electrolytes with lithium metal anodes in Li∥Li symmetric cell test, as shown in the data presented in FIG. 13A, further bolstered the electrochemical performances of these electrolytes. FEC and ETMSMC did not support lithium stripping/plating at all, and only TFPC was able to show stable voltage polarization for 50 hours approximately, while the rest of the other electrolytes became unstable with a higher overpotential within 22 hours of operation. Therefore, the Li∥Li symmetric cell test demonstrated that the poor electrochemical performance of the single solvents was due to their incompatibility with the lithium metal anode.

### Example 8

### Co-Solvent Performance

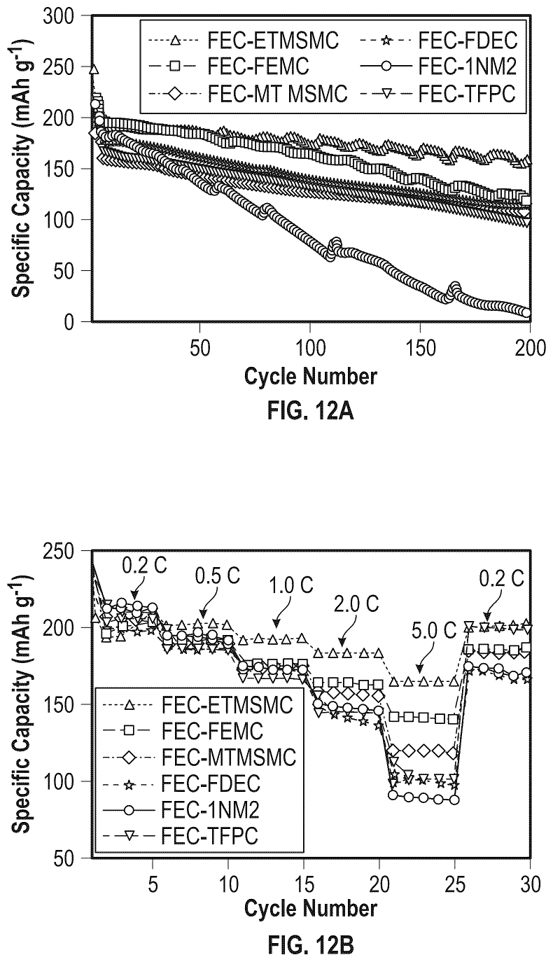

To identify the role of FEC in organic electrolytes typically used in Li-ion batteries, FEC was introduced in the above-mentioned single-solvent electrolytes and named a co-solvent electrolyte as shown in Table 5. FIG. 18 shows the excellent solubility of LiTFSI and LiDFOB in various co-solvents, i.e., a mixture of FEC with ETMSMC, MTMSMC, 1NM2, TFPC, FEMC, or FDEC. The electrochemical performance of these co-solvent electrolytes was evaluated in Li/NMC811 coin cells. The introduction of FEC in co-solvents dramatically changed the cyclic performance; for instance, ETMSMC as a single solvent showed the worst cyclic performance (FIG. 11A), however FEC-ETMSMC as a co-solvents delivered the highest specific capacity of 160 mAh g⁻¹ after 200 cycles compared to all other co-solvents as shown in FIG. 12A. After 200 cycles, NMC811 cathodes with different co-solvents such as FEC-MTMSMC, FEC-FEMC, FEC-TFPC, FEC-FDEC, and FEC-1NM2 delivered the specific capacities of 123 mAh g-1, 116 mAh g-1, 107 mAh g-1, 8 mAh g-1, and 4 mAh g-1, respectively.

It was concluded from the above results that: (1) the FEC electrolyte did not deliver any specific capacities with Li/NMC811 cells, which might be due to the presence of the C—F group in carbonated-based electrolytes (FEC), which was not compatible with Li/NMC811 cells; (2) carbonated-based electrolytes with the C—F3 group, such as TFPC and FEMC, delivered better electrochemical performance with Li/NMC811 as a single solvent electrolyte; (3) another class of carbonated-based electrolytes with the C—F3 group (FDEC) cannot be tested with Li/NMC811 because of the insolubility of LiTFSI and LiBFOB in FDEC solvent; (4) specific capacities of Li/NMC811 cells with organosilicon-based single electrolytes (ETMSMC, MTMSMC, and 1NM2) faded after a few initial cycles; (5) the addition of FEC in TFPC and FEMC-based electrolytes helped improve cyclic stability compared to single-solvent electrolytes; (6) Solubility of LiTFSI and LiBFOB in FDEC solvent improved after combing with FEC; however, the cyclic performance of Li/NMC811 with FEC-FDEC electrolyte was less stable compared to carbonated-based electrolytes with C—F3 group (FEC-TFPC and FEC-FEMC); (7) the introduction of FEC in organosilicon-based electrolytes helped Li/NMC811 to achieve stable cyclic performance compared to organosilicon-based single electrolytes; (8) organosilicon-ether-based co-solvent electrolytes (FEC-1NM2) performed worse than other co-solvent electrolytes; (9) organosilicon-carbonated-based co-solvent electrolytes with Si—O bond (FEC-ETMSMC) with Li/NMC811 cell outperformed the other co-solvent electrolytes; (10) organosilicon-carbonated-based co-solvent electrolytes with Si—C bond (FEC-MTMSMC) with Li/NMC811 cell had less performance than FEC-ETMSMC electrolytes.

Rate tests were performed on Li/NMC811 cells with co-solvent electrolytes, as shown in FIG. 12B. NMC811 cathodes delivered the specific capacities of 165 mAh g⁻¹, 143 mAh g⁻¹, 126 mAh g⁻¹, 120 mAh g⁻¹, 89 mAh g⁻¹, and 77 mAh g⁻¹ with FEC-ETMSMC, FEC-FEMC, FEC-FDEC, FEC-MTMSMC, FEC-1NM2, and FEC-TFPC, respectively. When the C-rate was switched back to 0.5 C, the NMC811 cathode with co-solvent electrolytes recovered to their respective specific capacities. These findings showed that Organosilicon-carbonated-based co-solvent electrolytes with Si—O bond (FEC-ETMSMC) outperformed other organic electrolytes even at higher C-rates.

### Example 9

### The Role of Co-Solvent Electrolytes in Performance-Enhanced Effect in Li/NMC811 Cells

To investigate the role of co-solvent electrolytes in performance-enhanced effect in Li/NMC811 cells, Li∥Li symmetric cells were studied as shown in FIG. 13A. All the co-solvents, except FEC-TFPC showed stable cycling performance and lower overpotential when compared with the baseline electrolyte. Both the baseline and FEC-TFPC displayed a neck-shaped voltage vs. time curve, with violent voltage ramping after 20 hours and 40 hours respectively, which indicated the growth and formation of dendrite at an early stage of operation. Among the remaining co-solvents, FEC-1NM2 presented the highest overpotential, though the stability of the cell was retained for 100 hours of operation.

The organo-silicon carbonate group containing co-solvents, FEC-ETMSMC and FEC-MTMSMC, showed nearly identical polarization until 100 hours. However, the two F-carbonate based co-solvents, FEC-FEMC and FEC-FDEC, exhibited resilient Li stripping/plating cycle behavior despite their downgraded performance compared with FEC-ETMSMC in the cyclic performance test (FIG. 12A). Thus, without being limited by theory, it is believed that a good compatibility with the cathode may be helping FEC-ETMSMC to possess a stable discharge capacity, whereas the other co-solvents are unable to extract that advantage.

### Example 10

### NMC811∥NMC811 Symmetric Cell Test

A NMC811∥NMC811 symmetric cell test was conducted, as shown in FIG. 13B, to understand the compatibility of the co-solvents with the NMC811 cathode. Upon cycling, initially, a protective layer at the cathode-electrolyte interface, known as the CEI layer, was formed. This layer thickened with subsequent cycling due to the solvents' oxidation and the catalytic decomposition of transition metal oxides from the NMC811 cathode. For the least-performing co-solvent electrolyte, FEC-1NM2, the solvent decomposed immediately after 3 hours of operation. In contrast, the promising electrolytes FEC-ETMSMC and FEC-FDEC showed better stability for 6.3 hours. The growing interfacial impedance caused by the thickening CEI layer contributed to an increased polarization voltage.

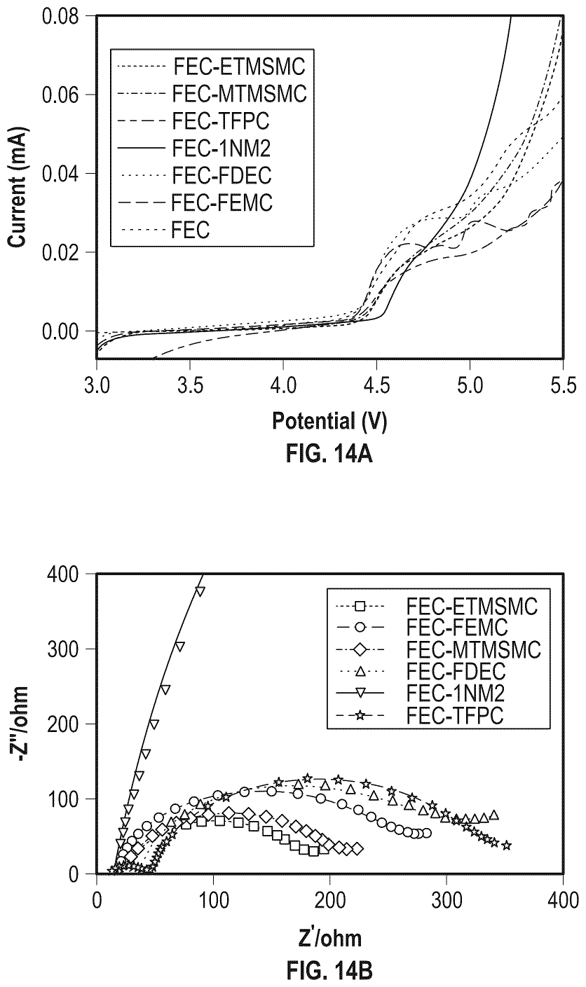

The oxidative LSV scan of co-solvent electrolytes as shown in FIG. 14A showed an oxidation onset potential of ˜4.4 V vs. a Li reference electrode, which indicated the oxidation onset potential depended on the presence of FEC in the co-solvent electrolyte.

### Example 11

Degradation Mechanism of the Li/NMC811 Battery Cells with Co-Solvent Electrolytes

Electrochemical Impedance Spectroscopy (EIS) measurements were conducted to investigate the degradation mechanism of the Li/NMC811 battery cells with co-solvent electrolytes after 200 cycles (full charge to no charge) of the Li/NMC811 cells (FIG. 14B).

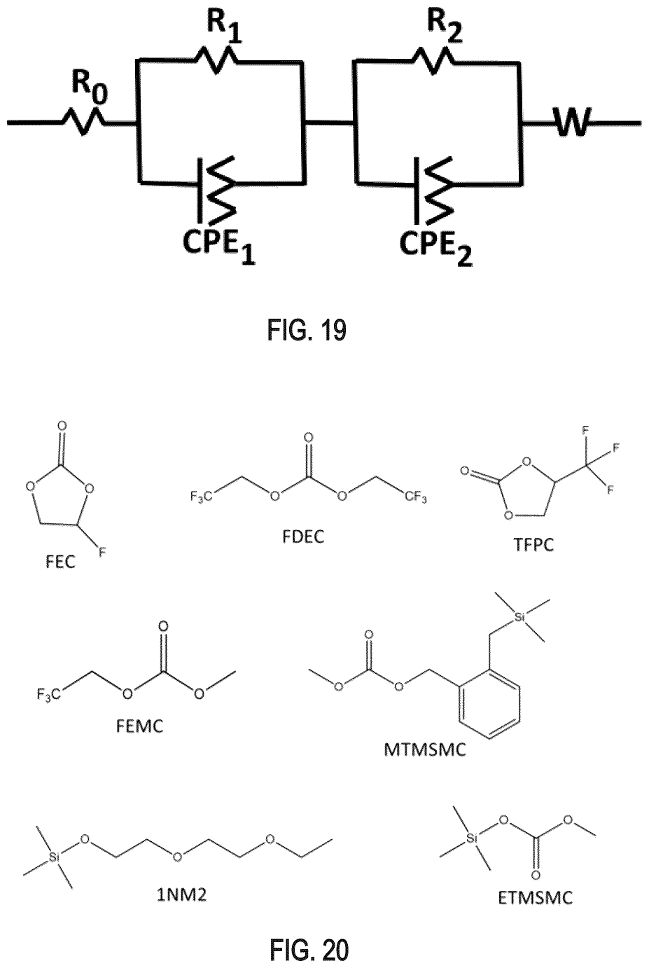

An equivalent circuit, R₀+CPE₁∥R₁+CPE₂∥R₂+W, was used to fit the EIS spectra as shown in FIG. 19, wherein R₀ is bulk resistance, CPE attributes for constant phase element, the symbol ∥ represents parallel circuit, CPE∥R represents interfacial impedance, and W is Warburg (mass transfer) impedance at low frequencies. The fitting parameters are tabulated in Table 6.

TABLE 6
EIS Equivalent Circuit Fitting Parameters for
Li/NMC811 Cells with Cosolvent Electrolytes

| Cell Description | R₀ (Ω) | R₁ (Ω) | R₂ (Ω) |
|---|---|---|---|
| FEC-ETMSMC | 12.5 | 162.3 | 12.5 |
| FEC-MTMSMC | 12.9 | 185.57 | 12.74 |
| FEC-TFPC | 13.1 | 297.24 | 33.0 |
| FEC-FEMC | 9.9 | 259.06 | 5.8 |
| FEC-1NM2 | 9.3 | 4836.3 | 5.1 |
| FEC-FDEC | 17.09 | 292.3 | 18.0 |

FIG. 14B shows the FEC-ETMSMC-based Li/NMC811 cell had lower charge transfer resistance (R1=177.1Ω) and anode interfacial resistance (R2=16.4Ω) as compared to other co-solvent electrolytes-based Li/NMC811 cells. As seen in Table 6 Li-NMC811 cells exhibited varying charge transfer and anode interfacial resistance depending on the type of co-solvent electrolyte used, with the following order of decreasing resistance: FEC-MTMSMC<FEC-FEMC<FEC-FDEC<FEC-TFPC<FEC-1NM2. The EIS results indicated that combining fluorinated solvent with organosilicon-ether-based electrolyte stabilizes the Li/NMC811 cell by preventing cathode surface degradation and protecting the Li-anode by forming the SEI layer after a repeated cycle.

### Example 12

### Ex-Situ XPS to Identify the Phase Transformation

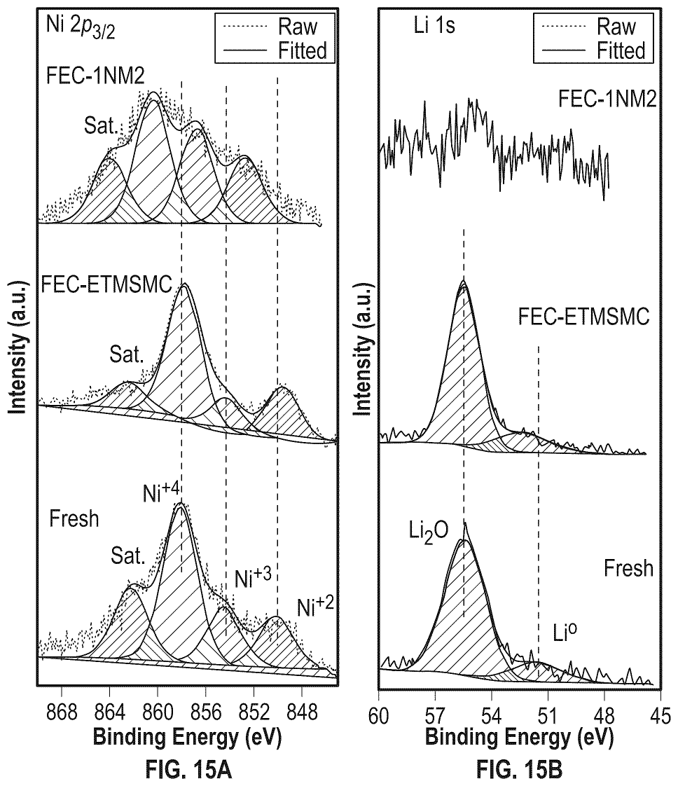

Ex-situ x-ray photoelectron spectroscopy (XPS) was conducted to identify the phase transformation in FEC-ETMSMC and FEC-1NM2 after 200 cycles. FIG. 15A shows the XPS data of fresh and cycled NMC811 cathodes with FEC-ETMSMC and FEC-1NM2 electrolytes. It was observed from the Ni 2p3/2 spectra that the FEC-ETMSMC-based Li/NMC811 cells retained the same binding energies for Ni⁺⁴ (858.1 eV), Ni⁺³ (854.4 eV), and Ni⁺² (850.2 eV) as in a fresh NMC811 cathode, which indicated the retention of structure morphology in FEC-ETMSMC-based Li/NMC811 after 200 cycles. However, the blueshift in binding energies of Ni⁺⁴, Ni⁺³, and Ni⁺² in the case of FEC-1NM2-based Li/NMC811 cell suggested the deformation in the structure of the NMC811 cathode when cycled with FEC-1NM2 after repeated cycling. FIG. 15B shows the retention of Li₂O (55.5 eV) and Li⁰ (52.1 eV) peaks in FEC-ETMSMC-based Li/NMC811 after 200 cycles at the same binding energies for fresh NMC811 cathode. The absence of Li Is peak indicated the deformation of the NMC811 cathode after repeated cycling. It was concluded from the XPS results that it was vital for the NMC811 cathode to retain its chemical structural morphology to get stable electrochemical performance after repeated cycling.

### Example 13

### Density Functional Theory to Calculated the HOMO and LUMO Levels of the Solvents

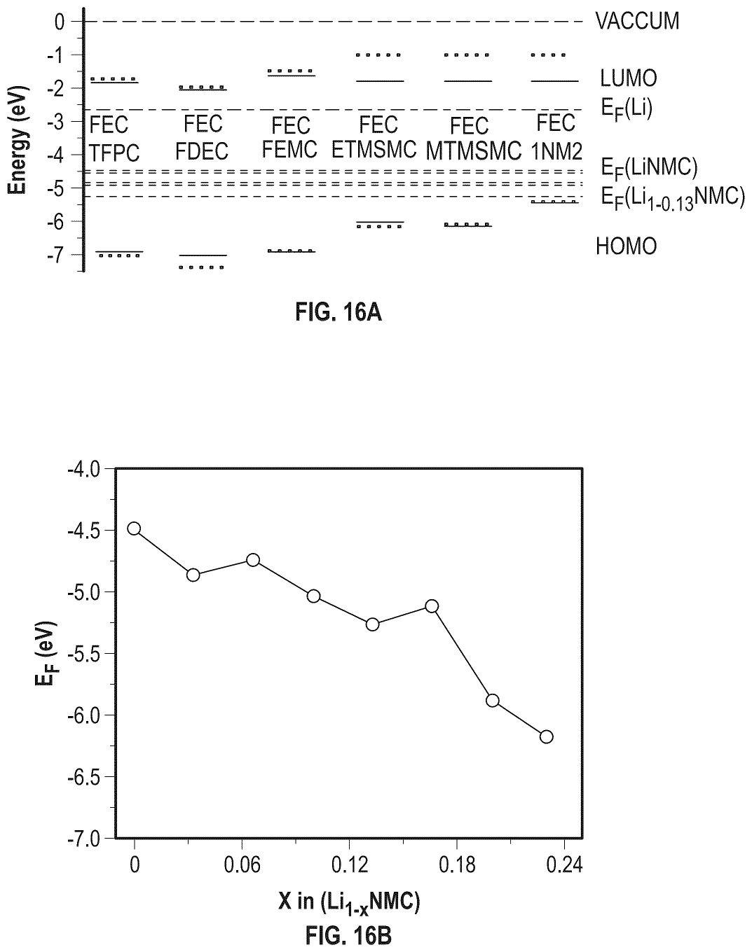

Using the Density Functional Theory (DFT) method, the highest occupied molecular orbitals (HOMO) and lowest unoccupied molecular orbitals (LUMO) levels of the isolated individual solvents and the solvents mixed with FEC (co-solvents) were calculated as shown in FIG. 16A. For single solvents it was found that fluorinated solvents (TFPC, FDEC, FEMC) had higher oxidation stability but lower reduction stability than the Si-based solvents (ETMSMC, MTMSMC, 1NM2). When the fluorinated solvent FEC was mixed with other fluorinated solvents, the HOMO-LUMO levels remained almost the same for the co-solvents compared to the single solvents. Whereas when FEC was mixed with Si-based solvents, the HOMO level of the co-solvents moves higher and the LUMO level moves lower. It was found that all the solvents showed electrochemical stability when their LUMO levels were higher and HOMO levels were lower than the Fermi energy levels of Li and LiNMC respectively. It was also found that the Fermi level of LiNMC decreased with de-lithiation as shown in FIG. 16B. In FIG. 16B, the Fermi level of NMC at different Li concentrations was calculated by keeping the volume of the LiNMC slab fixed.

### Example 14

Reactivity of Solvents with the Li Anode

To test the reactivity of solvents with the Li anode, the interfacial reaction energy of each solvent and co-solvent with the Li surface was calculated as shown in Table 7.

TABLE 7
Interfacial Reaction Energy (ΔE) of Single
Solvents and Co-solvents on Li and NMC Surfaces

| Single solvent | ΔE (eV) | Co-solvent | ΔE (eV) |
|---|---|---|---|
| FEC/Li | −6.03 | — | — |
| TFPC/Li | −5.54 | FEC_TFPC/Li | −5.84 |
| FDEC/Li | −4.24 | FEC_FDEC/Li | −4.56 |
| FEMC/Li | −4.89 | FEC_FEMC | −5.15 |
| ETMSMC/Li | −0.49 | FEC_ETMSMC/Li | −0.65 |
| MTMSMC/Li | −0.61 | FEC_MTMSMC/Li | −0.74 |
| 1NM2/Li | −0.76 | FEC_1NM2/Li | −0.85 |
| FEC/NMC | −0.48 | — | — |
| TFPC/NMC | −0.14 | FEC_TFPC/NMC | −0.06 |
| ETMSMC/NMC | −0.80 | FEC_ETMSMC/NMC | −0.24 |

As can be seen in Table 7, it was found that the fluorinated solvents were more reactive with Li than the Si-based solvents. It was also found that FEC mixed with fluorinated solvents were highly reactive with Li, as shown by the larger negative value of the interfacial reaction energy in Table 7. FEC mixed with Si-based solvents also showed reactivity with Li but was less reactive than fluorinated solvents as shown by the smaller negative interfacial reaction energy. The interaction of the solvents with the Li anodes formed the SEI layer in the battery¹⁻³. The formation of a stable transparent SEI layer resulted in the separation of the electrode and the electrolyte, which inhibited side reactions, improved stability, and therefore enhanced the cycle life of the battery.

The experimental results showed that mixing FEC with fluorinated solvents resulted in similar performance as the single solvents. In contrast, the mixing of FEC with Si-based solvents highly improved the cycle life. The interfacial reaction energy of the cathodes with the solvents and the co-solvents was calculated as shown in Table 7. The calculations showed that Si-based solvents (ETMSMC) were more reactive with the cathode than the fluorinated solvents (FEC and TFPC). The reactivity of the solvents with the cathode was shown to decrease when mixed with FEC. The experimental results showed that electrodes reacted with the solvents and the co-solvents to form SEI and CEI layers. The formation of LiF-based SEI and CEI layers enhanced the cyclic stability of the battery.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 8
List of Reference Characters

| | |
|---|---|
| 10 | Physical vapor deposition process, radio frequencies (RF) |
| | sputtering to deposit oxide layers in a Torr combination system |
| 11 | Ultrahigh vacuum chamber |
| 12 | Nickel rich cathode |
| 14 | Clips |
| 15 | Support mount |
| 16 | Oxide target |
| 17 | Argon ions |
| 18 | Outlet |
| 19 | Support member |
| 20 | Inlet |
| 22 | High-temperature resistant adhesive polyimide tape |
| 24 | Nickel-rich cathode material |
| 26 | Aluminum foil or ceramic plate |
| 30 | Graphical representation of FIG. 3 |
| 32 | Cell Voltage |
| 34 | Specific capacity in milliampere hours per gram mass (mAH/g) |
| 36 | Graph of cell voltage versus specific capacity in milliampere hours |
| | per gram mass (mAH/g) |
| 40 | Graphical representation of FIG. 4 |
| 42 | Specific capacity is defined as the amount of electric charge |
| | (“milliampere hours” or mAh) the material can deliver per gram |
| | of material. |
| 44 | Number of cycles |
| 46 | Graph of specific capacity versus the number of cycles for the high |
| | voltage electrolyte of an example embodiment of this disclosure |
| 48 | Graph of specific capacity versus the number of cycles for a baseline |
| | electrolyte |
| 50 | SEM images of NMC811 cathodes: pristine |
| 52 | SEM images of NMC811 cathodes: after 200 cycles with BE |
| 54 | SEM images of NMC811 cathodes: after 200 cycles with HVE |
| 56 | Digital photographs of Li metal anode disks as pristine |
| 58 | Digital photographs of Li metal anode disks after 200 cycles with BE |
| 60 | Digital photographs of Li metal anode disks after 200 cycles with |
| | HVE |
| 64 | The reactivity of added molecule FEC and NMC811 (001) surface |
| | from PBE + u DFT calculations is represented on a physisorbed |
| | molecule on the NMC811 surface |
| 66 | The reactivity of added molecule FEC and NMC811 (001) surface |
| | from PBE + μ DFT calculations is represented on a physisorbed |
| | molecule on the NMC811 surface where the small arrow shows the |
| | movement of H, and the large arrow shows the configuration after |
| | H-transfer. |

What is claimed is:

1. A lithium-ion battery comprising:
a cathode having a nickel content of at least 80%;
an anode;
an electrolyte, located between the anode and the cathode, that includes a fluorinated solvent, an additive, and a lithium salt; and
a separator providing a barrier between the anode and the cathode.

2. The lithium-ion battery according to claim 1, wherein the cathode includes active material comprising a lithium transition metal oxide, a lithium transition metal nitride, a lithium transition metal fluoride, a lithium transition metal sulfide, a lithium transition metal phosphate, or a mixture thereof.

3. The lithium-ion battery according to claim 1, wherein the cathode includes active material having a redux potential that ranges from about 4.3 volts to about 5 volts.

4. The lithium-ion battery according to claim 3, wherein the cathode includes active material having a redux potential that ranges from about 4.8 volts to about 5 volts.

5. The lithium-ion battery according to claim 1, wherein the cathode includes high redux active material comprising LiNixMnyCozO2 (x+y+z=1), LiNi1/3Mn1/3Co1/3O2 (NMC111), Ni-rich LiNi0.8Mn0.1Co0.1O2 (NMC811), Ni-rich LiNi0.6Mn0.2Co0.2O2 (NMC622), Ni-rich LiNi0.5Mn0.3Co0.2O2 (NMC532), LiMMnO4 (M=Cr, Co, Fe), LiNi0.5Mn1.5O4 (LNMO), LiCr0.1Ni0.4Mn1.5O4, LiM0.5Mn1.5O4 (M=Cr, Fe, Co, Ni, Cu), LiMg0.05Ni0.45Mn1.5O4, Li1.01Cu0.32Mn1.67O4, LiCo0.2Ni0.4Mn1.404, LiNiVO4, Li1.14Ni0.29Mn0.57O2, Li2CoPO4F, LiVPO4F, LiNiPO4, LiCoPO4, LiMn0.8Fe0.1M0.1PO4 (M=Fe, Co, Ni, Cu), Li-rich layered Li[Li1/3Mn2/3]O2-LiMO2 (or Li2MnO3-LiMO2), where M=Ni, Co, Mn, LiNi0.8Co0.15Al0.05O2 (NCA), LiNi1−x−yCoxAlyO2, Li2FeSiO4, Li2CoP2O7, Li2−xCoP2O7, or a mixture thereof.

6. The lithium-ion battery according to claim 1, wherein the separator comprises a polymer film, nonwoven fiber, cotton, nylon, polyesters, glass, rubber, asbestos, wood, block polymer derived nanoporous separators, or a combination thereof.

7. The lithium-ion battery according to claim 1, wherein the anode includes anode active material comprising a lithium metal, a metal predoped with lithium, a metal that is pre-lithiated, or a combination thereof.

8. The lithium-ion battery according to claim 1, wherein the anode includes anode active material selected from the group consisting of carbonaceous materials, lithium titanate spinel Li4Ti5O12, silicon (Si), germanium (Ge), tin (Sn), SiO, SiO2, SnO, SnO2, GeO, GeO2, metal alloy of Si, metal alloy of Ge, metal alloy of Sn, Fe2O3, CoO, Co3O4, TiO2, Cu2O, MnO, and a combination or mixture thereof.

9. The lithium-ion battery according to claim 1, wherein the fluorinated solvent comprises a fluorinated nitrile, a fluorinated carbonate, a fluorinated borate, a fluorinated ester, a fluorinated ether, a fluorinated sulfone, a fluorinated sulfide, a fluorinated acetal, a fluorinated phosphite, a fluorinated phosphate, or a combination or mixture thereof.

10. The lithium-ion battery according to claim 9, wherein the fluorinated solvent comprises a fluoroethylene carbonate, methyl trifluoroethyl carbonate, fluoroethyl methyl carbonate, bis (2,2,2-trifluoroethyl) carbonate, 3,3,3-trifluoropropylene carbonate, 2-trifluoromethyl-3-methoxyperfluoropentane, 1,1,2,2-tetrafluoroethyl 2,2,3,3-tetrafluoropropyl ether, 2-trifluoro-2-fluoro-3-difluoropropoxy-3-difluoro-4-fluoro-5-trifluoropentane, 2-trifluoromethyl-3-methoxyperfluoropentane, TFPC: 3,3,3-trifluoropropylene carbonate, bis(2,2,2-trifluoroethyl) carbonate, 1,1,2,2-tetrafluoroethyl 2,2,3,3-tetrafluoropropyl ether, bis(2,2,2-trifluoroethyl) carbonate, methyl (2,2,2-trifluoroethyl) carbonate, fluoroethylene carbonate, or a mixture thereof.

11. The lithium-ion battery according to claim 1, wherein the additive is a passivation film on the lithium metal anode and comprises a lithium polysulfides, a lithium nitrate, a phosphorous pentasulfide, Cu(CH3COO)2, lanthanum nitrate, vinylene carbonate, tris(trimethylsilyl) phosphitearious, succinonitrile, lithium difluoro(oxalato)borate, or a mixture thereof.

12. The lithium-ion battery according to claim 1, wherein the lithium salt comprises lithium hexafluorophosphate, lithium hexafluoroarsenate, lithium perchlorate, lithium tetrafluoroborate, lithium trifluoromethane sulfonate, lithium bis(fluorosulfonyl)imide, lithium bis(trifluoromethanesulfonyl)imide, lithium bis(pentafluoroethylsulfonyl)imide, lithium tris(trifluoromethylsulfonyl)methide, lithium trifluoro tris(pentafluoroethyl)phosphate, lithium bis(oxalato)borate, lithium hexafluoroisopropoxide, lithium malonate borate, lithium difluoro(oxalato) borate, lithium hexafluoroantimonate, LiPF6, LiBF4, LiN(CF3SO2)2 and (LiTFSI), or a mixture thereof.

13. The lithium-ion battery according to claim 1, wherein the fluorinated solvent is combined with an organosilicon-based solvents.

14. The lithium-ion battery according to claim 13, wherein the organosilicon-based solvent comprises 2,2-dimethyl-3,6,9-trioxa-2-siladecane, methyl (trimethylsilylmethyl) carbonate, ethyl (trimethylsilylmethyl) carbonate, or a mixture thereof.

15. A lithium-ion energy storage system comprising:
a cathode having a nickel content of at least 80%;
an anode;
an electrolyte, located between the anode and the cathode, that includes a fluorinated solvent, an additive, and a lithium salt; and
a separator providing a barrier between the anode and the cathode.

16. The lithium-ion storage system according to claim 15, wherein the fluorinated solvent is selected from the group consisting of a fluorinated nitrile, a fluorinated carbonate, a fluorinated borate, a fluorinated ester, a fluorinated ether, a fluorinated sulfone, a fluorinated sulfide, a fluorinated acetal, a fluorinated phosphite, a fluorinated phosphate, or a mixture thereof.

17. The lithium-ion storage system according to claim 15, wherein the additive is a passivation film on the lithium metal anode and comprises a lithium polysulfides, a lithium nitrate, a phosphorous pentasulfide, Cu(CH3COO)2, lanthanum nitrate, vinylene carbonate, tris(trimethylsilyl) phosphitearious, succinonitrile, lithium difluoro (oxalato) borate, or a mixture thereof.

18. The lithium-ion storage system according to claim 15, wherein the lithium salt is selected from the group consisting of lithium hexafluorophosphate, lithium hexafluoroarsenate, lithium perchlorate, lithium tetrafluoroborate, lithium trifluoromethane sulfonate, lithium bis(fluorosulfonyl)imide, lithium bis(trifluoromethanesulfonyl)imide, lithium bis(pentafluoroethylsulfonyl)imide, lithium tris(trifluoromethylsulfonyl) methide, lithium trifluoro tris(pentafluoroethyl)phosphate, lithium bis(oxalato) borate, lithium hexafluoroisopropoxide, lithium malonate borate, lithium difluoro (oxalato) borate, lithium hexafluoroantimonate, LiPF6, LiBF4, LiN(CF3SO2)2 and (LiTFSI), or a mixture thereof.

19. A method of manufacturing a lithium-ion battery comprising:
inserting an electrolyte that includes a fluorinated solvent, an additive, and a lithium salt carrying positively charged ions between a cathode having a nickel content of at least 80% and an anode, within a casing; and
inserting a separator between the anode and the cathode to block the flow of electrons inside the lithium-ion battery.

20. The method of manufacturing a lithium-ion battery according to claim 19, further comprising the step of applying the additive comprising a passivation film, to the anode as a coating in-situ.
